(19) United States
(12) Patent Application Publication
(10) Pub. No.: US 2003/0046696 A1
(43) Pub. Date: Mar. 6, 2003

(54) Broadcast terminal equipment and information supply system

(76) Inventors: Masataka Mizuno, Kobe (JP); Shuuichi Tsukamoto, Kobe (JP); Tatsuo Itou, Kobe (JP); Naoto Matsushita, Kobe (JP); Minoru Maehata, Kobe (JP); Makoto Asakura, Kobe (JP)

Correspondence Address: WENDEROTH, LIND & PONACK, L.L.P., 2033 K STREET N. W., SUITE 800, WASHINGTON, DC, 20006-1021, US

(21) Appl. No.: 10/233,442

(22) Filed: Sep. 4, 2002

(30) Foreign Application Priority Data
Sep. 5, 2001 (JP) J.P.268897/2001

(51) Int. Cl. G06F 3/00; H04N 5/445; G06F 13/00

(52) U.S. Cl. 725/46; 725/43

(57) ABSTRACT

The present invention was accomplished in order to provide broadcast terminal equipment and an information supply system, with which the convenience of a viewer can be improved by preparing a program list in which favorite programs of the viewer can be easily found out and automatically recording the viewer's favorite programs with the utilization of the viewer's watching program data, and moreover, a variety of information and services can be provided by making use of the viewer's watching program data with taking advantage of an interactive function, comprising a viewer's program data storage device to store program data related to programs a viewer watched, an each viewer's program list preparing device to prepare a favorite program list of the viewer based on the program data stored in the viewer's program data storage device, a favorite program detecting device to detect a program which fits into the favorite program list of the viewer prepared by the each viewer's program list preparing device in a program list received from a broadcasting business company side, and a differentiated display device to differentiate the program portion which fits into the favorite program of the viewer detected in the program list by the favorite program detecting device from other program portions for display when the program list is displayed.

### BACKGROUND OF THE INVENTION

1. Field of the Invention

The present invention relates to broadcast terminal equipment and an information supply system and, more particularly, to broadcast terminal equipment and an information supply system whereby the convenience of viewers is improved with the utilization of information related to viewers' watching programs and a variety of information and services can be provided with taking advantage of the interactivity.

2. Description of the Relevant Art

Television broadcasting has been shifting from conventional analog broadcasting to digital broadcasting. One of the characteristics of digital broadcasting is to have more channels. With more channels, viewers need to select programs which they want to watch out of a great number of programs.

As methods of selecting a program which a viewer watches, the viewer has decided a program to watch with checking the title, contents, performers or the like of the program by seeing a program list contained in a newspaper or a program list in a magazine such as a TV guide, or has selected a program to watch with sequentially switching a channel selection key of a remote control. In the case of using broadcast terminal equipment having a function of receiving digital broadcasting, the viewer can allow an electronic program guide supplied by a broadcast station to be displayed on the screen, and select a program to watch with seeing this electronic program guide.

In addition, as another characteristic of digital broadcasting, various types of services with taking advantage of the interactivity can be provided to viewers by mounting a modem on the broadcast terminal equipment having a receiving function and connecting that with a broadcast station side through a communication line.

As services with taking advantage of the interactivity, a service of preparing a viewer-participation program wherein viewers' replies to a quiz or a questionnaire in the program are transmitted through the communication line to the broadcast station side, on which they are collected and added by groups and the collected results are reflected to the program immediately, a service wherein the Internet and broadcast programs are combined, and the like can be exemplified. By connecting to the Internet, the user can make a reservation or a purchase of a ticket of a movie or a concert, a booking of a transmit system such as an airplane or a purchase of a ticket thereof, a reservation of a tour or a hotel, and the like on home pages. It has been possible to be provided with a variety of services.

However, the program list in a newspaper or a magazine such as a TV guide or the program list in the electronic program guide is prepared for providing common program information to general viewers. Therefore, since information for recognizing a favorite program of each viewer's own is not included therein, the viewer must carefully find out a program he/she wants to watch in such program lists. With more and more channels, the amount of information in the program lists increases, so that it takes time to just find out a program he/she wants to watch therein, and furthermore, the viewer is apt to miss his/her favorite program.

In addition, hitherto, in cases where a program is recorded using a recording unit such as a VCR, the recording has been programmed by previously entering items required such as the date and hour, channel and recording time of the program the viewer wants to record. However, when the broadcast schedule of the program is changed because of an extended broadcast time of a program such as a sportscast, a sudden insertion of an emergency newscast and the like, it is impossible to follow the change in the broadcast schedule, so that the viewer sometimes finds that the program programmed to record has not been recorded. Moreover, the viewer programs the recording by himself/herself with seeing a program list. With more and more channels, the viewer cannot sufficiently check the program list, so that the viewer is apt to overlook his/her favorite program and fail to record it.

And the services to viewers with taking advantage of the interactivity do not appear to be sufficient, and the services with the utilization of the watching program data of viewers have not been sufficiently developed.

### SUMMARY OF THE INVENTION

The present invention was accomplished in order to solve the above problems, and it is an object of the present invention to provide broadcast terminal equipment and an information supply system, with which the convenience of a viewer can be improved by preparing a program list in which favorite programs of the viewer are easily found out and automatically recording the viewer's favorite programs in order not to miss the viewer's favorite programs with the utilization of the viewer's watching program data, and moreover, a variety of information and services can be supplied by making use of the viewer's watching program data with taking advantage of an interactive function.

In order to achieve the above object, broadcast terminal equipment (1) according to the present invention is characterized by comprising a viewer's program data storage device to store program data related to programs a viewer watched, an each viewer's program list preparing device to prepare a favorite program list of the viewer, based on the program data stored in the viewer's program data storage device, a favorite program detecting device to detect a program which fits into the favorite program list of the viewer prepared by the each viewer's program list preparing device in a program list received from a broadcasting business company side, and a differentiated display device to differentiate the program portion which fits into the favorite program list of the viewer detected in the program list by the favorite program detecting device from other program portions for display when the program list is displayed.

Using the above broadcast terminal equipment (1), a program list in which favorite programs of the viewer can be easily found out can be prepared on the basis of the program data. The viewer can easily find out his/her favorite programs therein, so that it is possible to prevent the viewer from failing to notice his/her favorite programs, even if the number of programs increases with more and more channels.

Broadcast terminal equipment (2) according to the present invention is characterized by comprising a viewer's program data storage device to store program data related to programs a viewer watched, an each viewer's program list preparing device to prepare a favorite program list of the viewer, based on the program data stored in the viewer's program data storage device, a favorite program detecting device to detect a program which fits into the favorite program list of the viewer prepared by the each viewer's program list preparing device in a program list received from a broadcasting business company side, a programmed recording schedule check device to make sure of the programmed recording schedule of the favorite program of the viewer detected by the favorite program detecting device, and a recording control device to allow the favorite program of the viewer to be automatically recorded in a storage device when it is made sure by the programmed recording schedule check device that the programming of recording of the viewer's favorite program detected by the favorite program detecting device has not been conducted.

Using the above broadcast terminal equipment (2), even if the programming of recording of a favorite program of the viewer has not been conducted, the viewer's favorite program can be automatically recorded in the storage device. Therefore, even when the viewer has forgotten to program the recording, the viewer's favorite program can be recorded, resulting in no failure to record the viewer's favorite program. Here, as the storage device, a hard disk drive (hereinafter, referred to as an HDD) embedded in the broadcast terminal equipment and the like can be used.

Broadcast terminal equipment (3) according to the present invention is characterized by comprising a viewer's program data storage device to store program data related to programs a viewer watched, an each viewer's program list preparing device to prepare a favorite program list of the viewer, based on the program data stored in the viewer's program data storage device, a favorite program detecting device to detect a program which fits into the favorite program list of the viewer prepared by the each viewer's program list preparing device in a program list received from a broadcasting business company side, a programmed recording schedule check device to make sure of the programmed recording schedule of the favorite program of the viewer detected by the favorite program detecting device, and a recording direction device to transmit a recording direction signal to an outside recording unit so as to record the favorite program of the viewer when it is made sure by the programmed recording schedule check device that the programming of recording of the viewer's favorite program detected by the favorite program detecting device has not been conducted.

Using the above broadcast terminal equipment (3), even if the programming of recording of a favorite program of the viewer has not been conducted, a recording direction signal can be transmitted to the outside recording unit so as to record the viewer's favorite program. Therefore, the viewer's favorite program can be recorded by the outside recording unit, resulting in no failure to record the viewer's favorite program.

Broadcast terminal equipment (4) according to the present invention is characterized by comprising a program on-air detecting device to detect whether a favorite program of the viewer detected by the favorite program detecting device is on the air at turn-on of power, and a favorite program start-up device to start up the viewer's favorite program when the viewer's favorite program is detected being on the air by the program on-air detecting device in the above broadcast terminal equipment

Using the above broadcast terminal equipment (4), when a viewer's favorite program is on the air at turn-on of power, the viewer's favorite program can be first started up. Therefore, the viewer can save the trouble of selecting the favorite program, and watch the viewer's favorite program promptly.

Broadcast terminal equipment (5) according to the present invention is characterized by the favorite program start-up device, which starts up the viewer's favorite program a prescribed time after a start-up on the last channel or the like in the above broadcast terminal equipment (4).

Using the above broadcast terminal equipment (5), the viewer's favorite program is started up a prescribed time after the start-up on the last channel, a channel selected by the viewer or the like. Therefore, the viewer can save the trouble of selecting the favorite program, and furthermore, the viewer can know the automatic change to the viewer's favorite program, so that the viewer can watch the viewer's favorite program without feeling unnatural.

When the prescribed time is set to be about 5 seconds, for example, the broadcast program on the last channel is displayed for a short period of time, and then automatically switched to the viewer's favorite program, which enables the viewer to watch the current broadcast program on the last channel for his/her information. When the prescribed time is set to be a short period of time of 1 second or shorter, it is possible to make the viewer feel as if the viewer's favorite program had been automatically started up first.

Broadcast terminal equipment (6) according to the present invention is characterized by the favorite program start-up device, which starts up the viewer's favorite program a random time of a prescribed range after a start-up on the last channel or the like in the above broadcast terminal equipment (4).

Using the above broadcast terminal equipment (6), the viewer's favorite program is started up a random time of a prescribed range after the start-up on the last channel. Therefore, the viewer can save the trouble of selecting the favorite program, and watch the viewer's favorite program without feeling unnatural.

When the random time of a prescribed range is set to be about 4-5 seconds, for example, the broadcast program on the last channel is displayed for a short period of time, and then automatically switched to the viewer's favorite program, which enables the viewer to watch the current broadcast program on the last channel for his/her information. When the random time of a prescribed range is set to be about 0.5-1 second, it is possible to make the viewer feel as if the viewer's favorite program had been automatically started up first. In the control of setting such random time of a prescribed range, when the program on the last channel which the viewer had watched lately is the viewer's favorite program, for example, the time may be made a long time of about 4-5 seconds, while when it is not the viewer's favorite program, the time may be made a short time of about 0.5-1 second. Thus, it is possible to control the setting of the switching time on a random basis according to a certain condition.

Broadcast terminal equipment (7) according to the present invention is characterized by comprising a satisfied display condition judging device to judge the satisfaction of a display condition to a display device, wherein the favorite program start-up device starts up the viewer's favorite program when the satisfied display condition judging device judges the display condition to have been satisfied after a start-up on the last channel or the like in the above broadcast terminal equipment (4).

Using the above broadcast terminal equipment (7), since the viewer's favorite program is started up when the satisfied display condition judging device judges the display condition to have been satisfied after a start-up on the last channel or the like, the viewer can save the trouble of selecting the favorite program, and watch the viewer's favorite program at once.

As the display condition, the completion of heating a heater of a TV picture tube, the end of a mute signal showing the completion of selecting a broadcast station (the start of outputting a broadcast receiving sound through a speaker) and the like are exemplified. The viewer's favorite program can be started up at the timing when the display condition of the display device is satisfied, so that the matching with the operating conditions of a display circuit varying depending on the operating environments such as room temperature and an interval of the power-off time of the equipment can be achieved.

Broadcast terminal equipment (8) according to the present invention is characterized by the program data stored in the viewer's program data storage device, including reception information such as the watching date, day of the week, receiving channel and watching time, and reference information such as genre classification into movie, news, sports, drama and the like previously entered in the program data and personality information such as actors, singers and TV personalities to appear in any of the above broadcast terminal equipments (1)-(7).

Using the above broadcast terminal equipment (8), since the reception information and the reference information are included in the program data, the program data can be useful in an analysis of the viewer's favorite programs, on the basis of the reception information and the reference information, so that a favorite program list of the viewer can be easily and exactly prepared.

Broadcast terminal equipment (9) according to the present invention is characterized by comprising a display control device to display a home page address to acquire a program list prepared by a broadcast station based on the input of an operating signal from an operating device whereby various types of setting operations can be conducted, an access device to access the home page address based on the selection of the home page address displayed by the control of the display control device, and a storage control device to download the program list through the home page accessed by the access device.

Using the above broadcast terminal equipment (9), since the program list can be automatically downloaded, the viewer can obtain the program list without subscribing a newspaper, a magazine or the like, and by making scattered program lists into one, it is possible to provide a program list easy to read for the viewer.

An information supply system (1) according to the present invention is characterized by broadcast terminal equipment, comprising a viewer's program data storage device to store program data related to programs a viewer watched and a program data transmitting device to transmit the program data stored in the viewer's program data storage device to an information center, and the information center, comprising a first specific information transmitting device to analyze the program data transmitted by the program data transmitting device and add specific information suiting the viewer's program taste to the program data so as to transmit the same to the broadcast terminal equipment.

Using the above information supply system (1), the broadcast terminal equipment can acquire the specific information transmitted from the information center, and supply the specific information to the viewer. Therefore, the viewer can obtain useful information suiting the viewer's taste such as detailed information of the program, information about performers, information about a changed time of the program by referring to the specific information having contents related to the program, leading to an improvement in convenience of the viewer.

An information supply system (2) according to the present invention is characterized by broadcast terminal equipment, comprising a viewer's program data storage device to store program data related to programs a viewer watched and a program data transmitting device to transmit the program data stored in the viewer's program data storage device to an information center, the information center, comprising an analyzed data transmitting device to analyze the program data transmitted by the program data transmitting device and transmit the analyzed data to a broadcast station, and the broadcast station, comprising a second specific information transmitting device to add specific information suiting the viewer's program taste based on the analyzed data transmitted by the analyzed data transmitting device so as to transmit the same to the broadcast terminal equipment.

Using the above information supply system (2), the broadcast terminal equipment can acquire the specific information transmitted from the broadcast station, and supply the specific information to the viewer. Therefore, the viewer can obtain useful information suiting the viewer's taste such as detailed information of the program, information about performers, information about a changed time of the program by referring to the specific information having contents related to the program, leading to an improvement in convenience of the viewer.

An information supply system (3) according to the present invention is characterized by the broadcast terminal equipment, comprising a recording time changing device to change the preselected recording time of a program to be recorded, when the specific information transmitted by the first specific information transmitting device or the second specific information transmitting device includes information about a changed broadcast time of the program to be recorded in the above information supply system (1) or (2).

Using the above information supply system (3), the preselected recording time of the program to be recorded can be automatically changed when the specific information includes the information about a changed broadcast time of the program to be recorded, so that it is possible to prevent a failure to record the program to be recorded with the changed broadcast time.

An information supply system (4) according to the present invention is characterized by the program data stored in the viewer's program data storage device, including reception information such as the watching date, day of the week, receiving channel and watching time, and reference information such as genre classification into movie, news, sports, drama and the like previously entered in the program data and personality information such as actors, singers and TV personalities to appear in any of the above information supply systems (1)-(3).

Using the above information supply system (4), since the program data includes the reception information and the reference information, the reception information and the reference information can be utilized to be useful for analyzing the viewer's favorite programs, so that a list of the viewer's favorite programs can be prepared easily and exactly.

An information supply system (5) according to the present invention is characterized by being an information supply system, wherein communication is conducted between broadcast terminal equipment and an information center, and information about the receiving operation state of the broadcast terminal equipment can be grasped in the information center, the broadcast terminal equipment, comprising a receiving operation data transmitting device to transmit the receiving operation data of a viewer on the broadcast terminal equipment to the information center, and the information center, comprising a receiving operation data collecting device to collect the receiving operation data transmitted from the broadcast terminal equipment, a viewer's information presumption device to presume the viewer's at-home state, the viewer's age and the like based on the receiving operation data collected by the receiving operation data collecting device, and a viewer's information transmitting device to transmit the viewer's information presumed by the viewer's information presumption device to a user of the viewer's information.

Using the above information supply system (5), the information center can collect the receiving operation data transmitted from the broadcast terminal equipment and presume the viewer's information such as the at-home state of the viewer from the collected receiving operation data, so that the information center can transmit the presumed viewer's information to the user thereof. Therefore, the user who receives the viewer's information can provide efficient services with taking advantage of the viewer's information. For example, if the user is a package delivery company or a bill collector, by making a visit for delivery or bill collecting during the time period when the viewer's at-home probability is presumed to be high from the viewer's information, the second trouble such as redelivery caused by the viewer's absence can be reduced, resulting in higher efficiency of delivery or bill collecting.

An information supply system (6) according to the present invention is characterized by being an information supply system, wherein communication is conducted between broadcast terminal equipment and an information center, and receiving program data of the broadcast terminal equipment can be grasped in the information center, the broadcast terminal equipment, comprising a viewer's program data storage device to store program data related to programs a viewer watched, and a program data transmitting device to transmit the program data stored in the viewer's program data storage device to the information center, and the information center, comprising a program data collecting device to collect the program data transmitted from the broadcast terminal equipment, a reference information frequency totaling device to total the frequency of reference information included in the program data based on the program data collected by the program data collecting device, an announcement information searching device to search an announcement information database in which announcement information for sales promotion related to the reference information is entered for the announcement information related to the reference information, when some information having a frequency of a prescribed times or more exists in the reference information based on the totaling results by the reference information frequency totaling device, and an announcement information transmitting device to transmit announcement information to the broadcast terminal equipment when the announcement information related to the reference information is found by the announcement information searching device.

Using the above information supply system (6), the broadcast terminal equipment can receive the announcement information transmitted from the information center and provide the viewer with the announcement information related to the reference information such as a ticket for a concert or sports. Therefore, the viewer can obtain the announcement information suiting his/her taste while watching TV, and make a reservation or a purchase of a ticket or an application for presents according to the announcement information, resulting in a higher convenience of the viewer. And the provider of the announcement information can conduct sales promotion of articles such as tickets effectively, thanks to the supply of the announcement information to fans.

### BREIF DESCRIPTION OF THE DRAWINGS

FIG. 1 is a block diagram schematically showing the principal part of broadcast terminal equipment according to an embodiment (1) of the present invention;

FIG. 2 is a storage format of viewer's program data stored in memory of the broadcast terminal equipment according to the embodiment (1);

FIG. 3 is a storage format of a viewer's favorite program list stored in memory of the broadcast terminal equipment according to the embodiment (1);

FIG. 4 is a storage format of favorite broadcast program data stored in memory of the broadcast terminal equipment according to the embodiment (1);

FIG. 5 is a diagram showing an example of a program list shown on a display panel of the broadcast terminal equipment according to the embodiment (1);

FIG. 6 is a flow chart showing the detecting operation of a favorite program of a viewer performed by a microcomputer of the broadcast terminal equipment according to the embodiment (1);

FIG. 7 is a flow chart showing the detecting operation of a favorite program of a viewer performed by the microcomputer of the broadcast terminal equipment according to the embodiment (1);

FIG. 8 is a flow chart showing the displaying operation of a program list performed by the microcomputer of the broadcast terminal equipment according to the embodiment (1);

FIG. 9 is a flow chart showing the acquiring operation of a program list performed by the microcomputer of the broadcast terminal equipment according to the embodiment (1);

FIG. 10 is a flow chart showing the automatic recording operation of a favorite broadcast program performed by the microcomputer of the broadcast terminal equipment according to the embodiment (1);

FIG. 11 is a flow chart showing the first favorite program starting-up operation performed by the microcomputer of the broadcast terminal equipment according to the embodiment (1);

FIG. 12 is a flow chart showing the second favorite program starting-up operation performed by the microcomputer of the broadcast terminal equipment according to the embodiment (1);

FIG. 13 is a block diagram schematically showing the principal part of a digital broadcasting system in which an information supply system (1) according to an embodiment of the present invention is adopted;

FIG. 14 is a diagram showing a storage format of program specific information stored in a program specific information database of a broadcast station constituting the digital broadcasting system in which the information supply system (1) according to the embodiment is adopted;

FIG. 15 is a flow chart showing the information supplying operation performed by a microcomputer of broadcast terminal equipment, a center controller of an information center, and a station controller of the broadcast station in the digital broadcasting system in which the information supply system (1) according to the embodiment is adopted;

FIG. 16 is a block diagram schematically showing the principal part of a digital broadcasting system in which an information supply system (2) according to an embodiment of the present invention is adopted;

FIG. 17 is a diagram showing a storage format of receiving operation information stored in a receiving operation information database of an information center constituting the digital broadcasting system in which the information supply system (2) according to the embodiment is adopted;

FIG. 18 is a diagram showing a storage format of viewer's information stored in a viewer's information database of the information center constituting the digital broadcasting system in which the information supply system (2) according to the embodiment is adopted;

FIG. 19 is a flow chart showing the information supplying operation performed by a microcomputer of broadcast terminal equipment and a center controller of the information center in the digital broadcasting system in which the information supply system (2) according to the embodiment is adopted;

FIG. 20 is a block diagram schematically showing the principal part of a digital broadcasting system in which an information supply system (3) according to an embodiment of the present invention is adopted;

FIG. 21 is a diagram showing a storage format of announcement information stored in an announcement information database of an information center constituting the digital broadcasting system in which the information supply system (3) according to the embodiment is adopted;

FIG. 22 is a diagram showing a display example of announcement information shown on a display panel of broadcast terminal equipment constituting the digital broadcasting system in which the information supply system (3) according to the embodiment is adopted; and

FIG. 23 is a flow chart showing the information supplying operation performed by a microcomputer of the broadcast terminal equipment and a center controller of the information center in the digital broadcasting system in which the information supply system (3) according to the embodiment is adopted.

### DESCRIPTION OF THE PREFERRED EMBODIMENTS

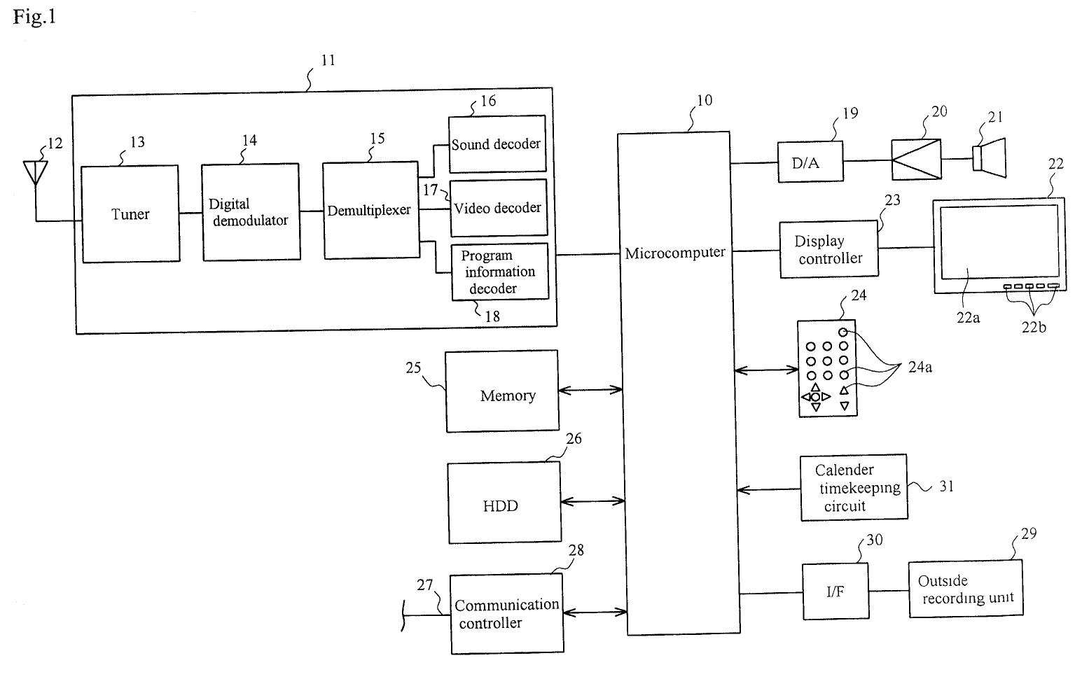

The preferred embodiments of the broadcast terminal equipment and the information supply system according to the present invention are described below by reference to those figures. FIG. 1 is a block diagram schematically showing the principal part of broadcast terminal equipment according to an embodiment (1), which is adopted as a receiving terminal of digital broadcasting.

A digital broadcasting receiver 11 is connected to a microcomputer 10, and the digital broadcasting receiver 11 comprises a tuner 13 which receives broadcast waves through an antenna 12, a digital demodulator 14 which demodulates a signal modulated by a prescribed digital modulation system depending on a characteristic of a transmission line to a transport stream (hereinafter, referred to as a TS) of the original digital signal, a demultiplexer 15 which isolates sound data, video data and program information data, etc. of a selected channel from the demodulated TS, a sound decoder 16 which decodes the sound data isolated in the demultiplexer 15, a video decoder 17 which decodes the video data and a program information decoder 18 which decodes the program information data. Each part of the digital broadcasting receiver 11 is controlled by the microcomputer 10.

To the microcomputer 10, a speaker 21 is connected through a digital-to-analog converter (hereinafter, referred to as a D/A converter) 19 and an amplifier 20. A digital sound signal decoded in the sound decoder 16 is converted to an analog sound signal in the D/A converter 19, is amplified in the amplifier 20, and then is output as a sound through the speaker 21. And to the microcomputer 10, a display monitor 22 is connected through a display controller 23. A digital video signal decoded in the video decoder 17 is converted to an analog video signal, and then is output to the display monitor 22 so as to be displayed as an image on a display panel 22a. Here, in this embodiment, the D/A converter 19 and the display controller 23 are connected to the digital broadcasting receiver 11 through the microcomputer 10, but the construction is not limited to the above. The sound decoder 16 and the video decoder 17 may be connected to the D/A converter 19 and the display controller 23, respectively, so that each part may be controlled by the microcomputer 10. As the construction wherein each part is controlled by the microcomputer 10, a variety of embodiments can be adopted.

The program information data decoded in the program information decoder 18 is stored in a memory 25. The microcomputer 10 conducts the control of reading the program information data out of the memory 25, preparing a prescribed program list, and outputting it to the display monitor 22 for display as a program list on the display panel 22a based on an input signal from a program list switch (not shown) arranged on a remote control 24.

On the remote control 24, button switches 24a for operations or setting such as a power switch, a channel selection switch, a volume control switch, a communication connecting switch and the like are mounted, besides the program list switch. Switch signals input through the button switches 24a or switch signals input through button switches 22b arranged on the display monitor 22 are input to the microcomputer 10, wherein processing corresponding to these switch signals is conducted. In addition, to the microcomputer 10, the memory 25, an HDD 26 for storing broadcast programs according to the directions from the microcomputer 10, a communication controller 28 for connecting to the Internet, outside media or the like through a communication line 27, an interface (hereinafter, referred to as an I/F) 30 for connecting with an outside recording unit 29 and a calendar timekeeping circuit 31 are connected.

As the communication controller 28, for example, a modem can be used in the case of the communication line 27 being an analog line, and a DSU (Digital Service Unit) in the case of the communication line 27 being a digital line. Whatever may be adopted depending on the characteristics of the communication line 27.

As the outside recording unit 29, a video recorder, a DVD recorder, an HD recorder and the like to record in magnetic tapes, optical disks, HDDs and the like can be adopted.

In the memory 25, an area for storing program information data captured by receiving from the digital broadcasting receiver 11, an area for storing viewer's program data related to programs a viewer watched, an area for storing a viewer's favorite program list judged from the watching tendency of the past viewer's program data, and an area for storing favorite broadcast program data showing a viewer's favorite program recognized by checking the received and captured program information data with the viewer's favorite program list, are included.

In the program information data, data regarding program lists for showing scheduled broadcast programs of every broadcast station like a TV section of a newspaper and reference information to be added to each program are included. In the reference information, detailed information and key words related to the program such as the genre classification of the program, performers who appear therein, characters who show up and the opposite team are included.

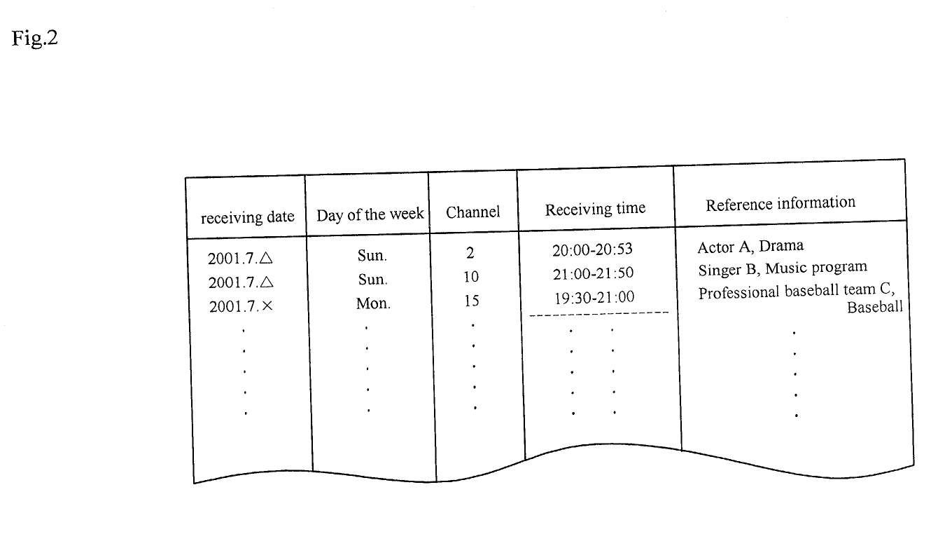

FIG. 2 is a diagram showing a storage format of the viewer's program data stored in the memory 25. Receiving dates, days of the week, channels, receiving times and reference information are included in the viewer's program data, wherein data regarding the programs the viewer watched are stored in time sequence.

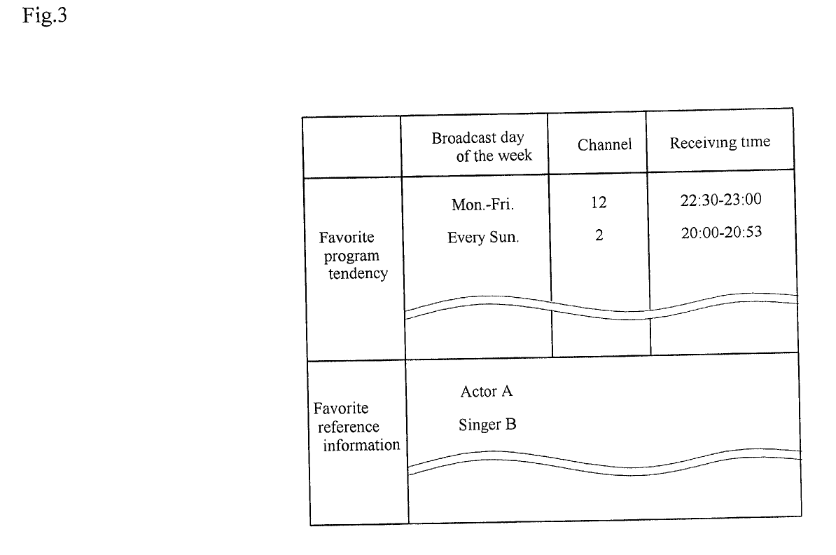

FIG. 3 is a diagram showing a storage format of the viewer's favorite program list stored in the memory 25. In the viewer's favorite program list, broadcast days of the week, channels and receiving times of the viewer's favorite programs selected after recognizing the tendency of the favorite programs of the viewer from the viewer's program data shown in FIG. 2 and favorite reference information are stored.

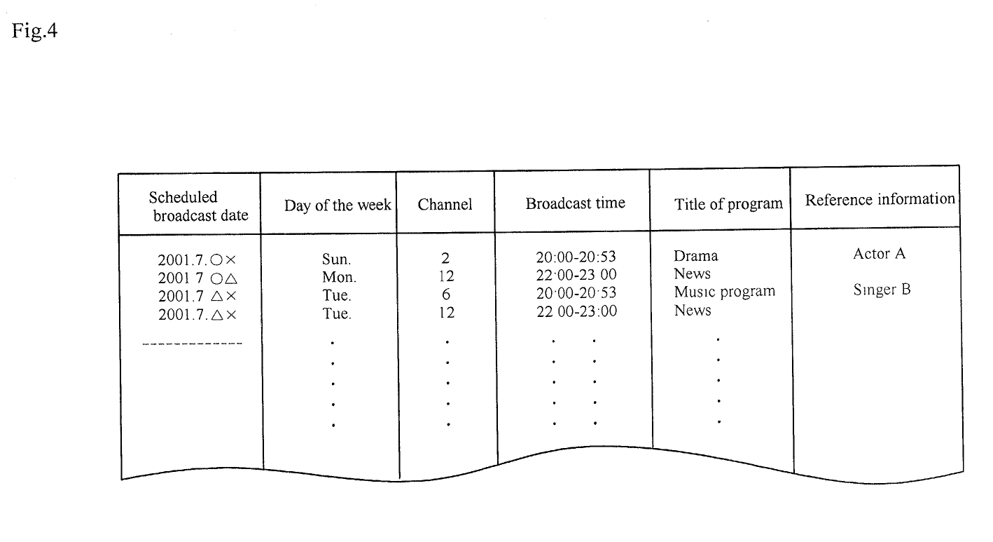

FIG. 4 is a diagram showing a storage format of the favorite broadcast program data stored in the memory 25. In the favorite broadcast program data, scheduled broadcast dates, days of the week, channels, program titles and reference information of the viewer's favorite broadcast programs recognized by checking a program list of the program information data with the viewer's favorite program list are stored.

For example, when an input signal of the program list display switch is input to the microcomputer 10 from the remote control 24, the microcomputer 10 checks the program information data with the viewer's favorite program list from the memory 25. When the microcomputer 10 detects a favorite broadcast program existing in the program list to be displayed, it stores the detected broadcast program as favorite broadcast program data and conducts the control of preparing a program list processed with marking or the like of the favorite broadcast program portion and outputting the prepared program list to the display monitor 22.

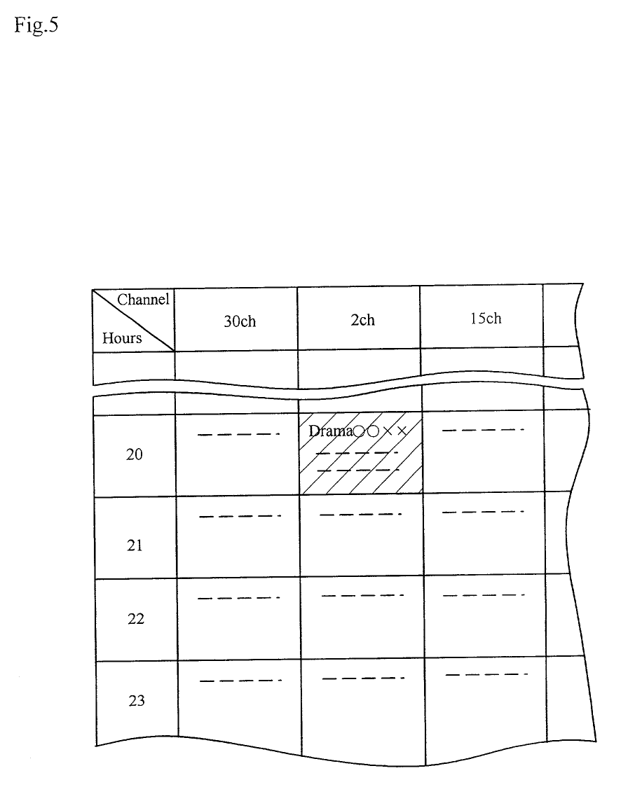

FIG. 5 shows a program list wherein a favorite broadcast program portion is marked. The viewer's favorite program (2 ch, Drama O O X X) portion is marked with coloring the background in the program space so that the program is easily known from other programs. Here, except marking, the size, font, or color of letters in the program space may be changed. It is only necessary to differentiate the viewer's favorite program from other programs to display the program so that it can be easily known from others.

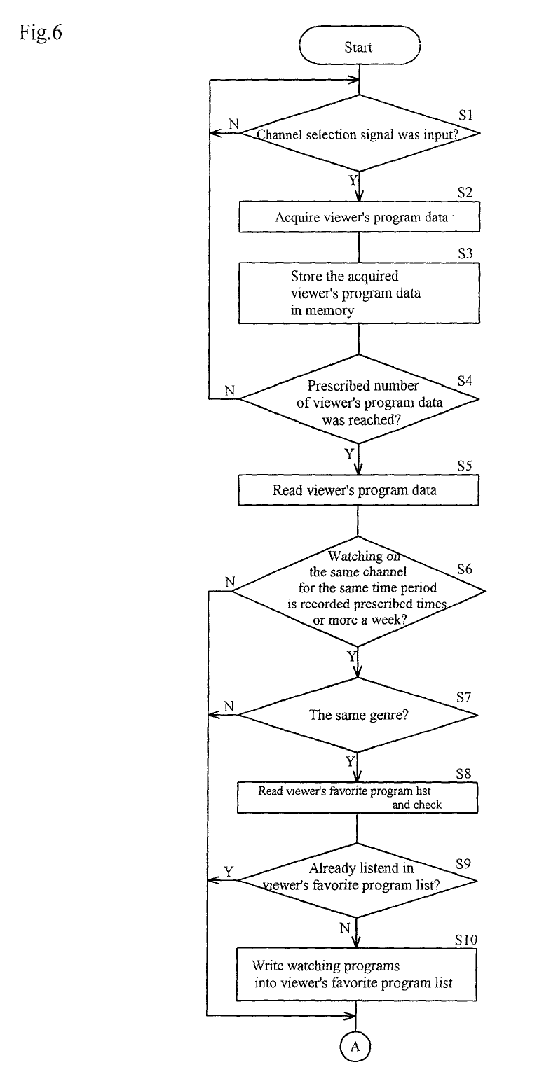

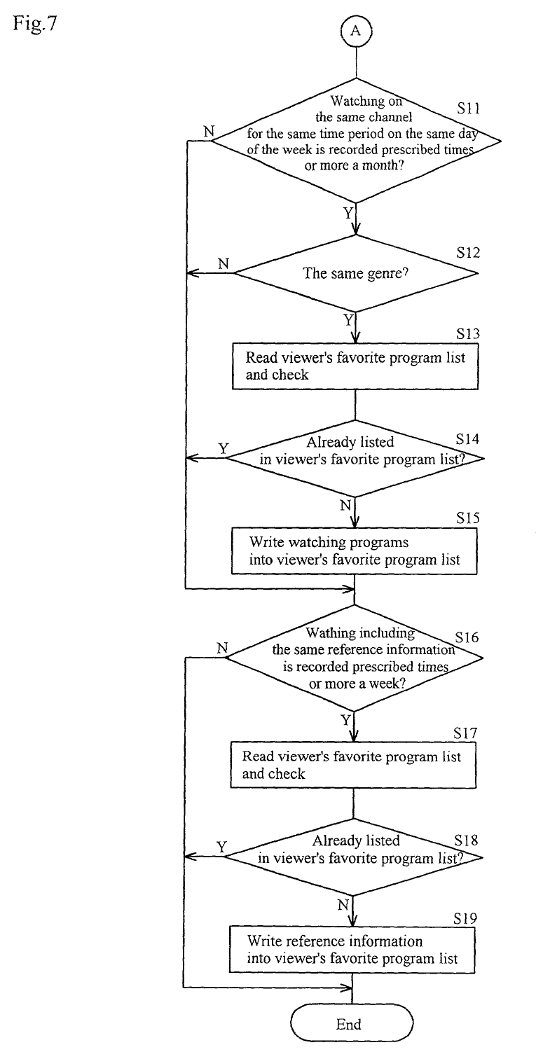

The detecting operation of favorite programs performed by the microcomputer 10 of the broadcast terminal equipment according to the embodiment (1) is described below by reference to flow charts shown in FIGS. 6 and 7.

In Step 1, whether or not a channel selection signal is input from the button switch 24a arranged on the remote control 24 or the button switch 22b arranged on the display monitor 22 is judged. When a channel selection signal is judged to have been input, the operation goes to Step 2, wherein the viewer's program data of the selected channel is acquired. On the other hand, when a channel selection signal is judged otherwise in Step 1, it returns to Step 1. The acquisition of the viewer's program data in Step 2 can be achieved by reading the program information data stored in the memory 25 and finding the broadcast program on the selected channel at the present date and hour in the program information data. After acquiring the viewer's program data, it goes to Step 3. In Step 3, the obtained viewer's program data is stored in the memory 25 with the storage format as shown in FIG. 2, and it goes to Step 4.

In Step 4, whether the number of the viewer's program data stored in the memory 25 reaches a prescribed data number or not is judged. When the number of the viewer's program data is judged to have reached the prescribed data number in Step 4, the operation goes to Step 5, wherein the viewer's program data stored in the memory 25 is read out, and it goes to Step 6.

On the other hand, when the number of the viewer's program data is judged otherwise in Step 4, the operation returns to Step 1. Here, in Step 4, whether a prescribed period elapsed or not may be judged, besides judging whether the number of the viewer's program data reached the prescribed number.

In Step 6, whether or not there are watching programs on the same channel for the same period of time, where watching is recorded prescribed times a week, for example, three times or more among the read viewer's program data, is judged. When it is judged that there are watching programs on the same channel for the same period of time where watching is recorded three times or more a week in Step 6, it goes to Step 7, wherein whether the watching programs belong to the same genre or not is judged. When the watching programs are judged to belong to the same genre, it goes to Step 8, wherein the viewer's favorite program list is read from the memory 25 and the watching programs are checked with programs listed in the viewer's favorite program list, and it goes to Step 9.

In Step 9, whether listing of the watching programs in the viewer's favorite program list is finished or not is judged. When the listing thereof is judged to have been finished in Step 9, the operation goes to Step 11 of FIG. 7, while when the listing thereof is judged otherwise, it goes to Step 10, wherein the watching programs are written into the viewer's favorite program list, and it goes to Step 11.

On the other hand, when it is judged that there is no watching program on the same channel for the same period of time where watching is recorded three times or more a week in Step 6, it goes to Step 11. And when the watching programs are judged not to belong to the same genre in Step 7, it goes to Step 11.

Step 11, whether or not there are watching programs on the same channel for the same period of time on the same day of the week where watching is recorded prescribed times a month, for example, twice or more is judged. When it is judged that there are watching programs on the same channel for the same period of time on the same day of the week where watching is recorded twice or more a month in Step 11, it goes to Step 12, wherein whether the watching programs belong to the same genre or not is judged. When the watching programs are judged to belong to the same genre, it goes to Step 13, wherein the viewer's favorite program list is read from the memory 25 and the watching programs are checked with programs listed in the viewer's favorite program list, and it goes to Step 14.

In Step 14, whether listing of the watching programs in the viewer's favorite program list is finished or not is judged. When the listing thereof is judged to have been finished, the operation goes to Step 16, while when the listing thereof is judged otherwise, it goes to Step 15, wherein the watching programs are written into the viewer's favorite program list, and it goes to Step 16.

On the other hand, when it is judged that there is no watching program on the same channel for the same period of time on the same day of the week where watching is recorded twice or more in Step 11, it goes to Step 16. And when the watching programs are judged not to belong to the same genre, it goes to Step 16.

In Step 16, whether or not there are watching programs including the same reference information which the viewer watched prescribed times a week, for example, three times or more among the viewer's program data is judged. When it is judged that there are watching programs including the same reference information watched three times or more a week in Step 16, it goes to Step 17. On the other hand, it is judged that there is no program including the same reference information watched three times or more a week in Step 16, leading to the end of the processing.

In Step 17, the viewer's favorite program list is read from the memory 25 and the reference information is checked with the reference information listed in the viewer's favorite program list, and it goes to Step 18. In Step 18, whether listing of the reference information is finished or not is judged. When the listing thereof is judged to have been finished, the processing is ended. On the other hand, when the listing thereof is judged otherwise, it goes to Step 19, wherein the reference information is written into the viewer's favorite program list, leading to the end of the processing.

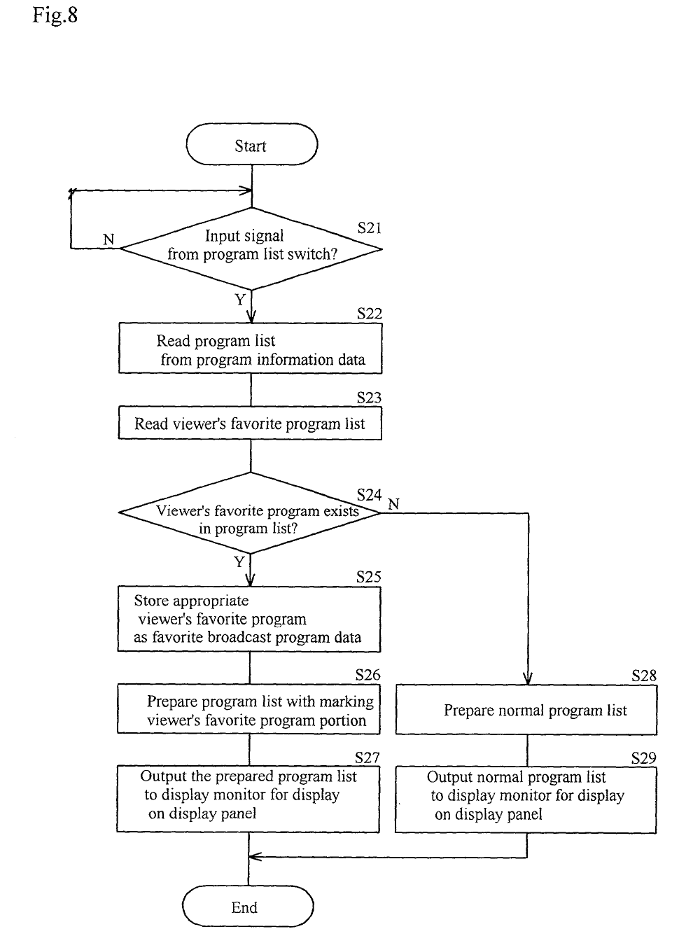

The program list displaying operation performed by the microcomputer 10 of the broadcast terminal equipment according to the embodiment (1) is described below by reference to a flow chart shown in FIG. 8.

In Step 21, whether there is an input signal from the program list switch arranged on the remote control 24 or not is judged. When it is judged that there was an input signal from the program list switch in Step 21, the operation goes to Step 22, wherein a program list is read from the program information data stored in the memory 25, and it goes to Step 23. In Step 23, the viewer's favorite program list stored in the memory 25 is read out, and it goes to Step 24. On the other hand, when it is judged that there was not an input signal from the program list switch in Step 21, it returns to Step 21.

In Step 24, whether or not there is a viewer's favorite program listed in the viewer's favorite program list among the read program list. When it is judged that there is a viewer's favorite program listed in the viewer's favorite program list among the read program list in Step 24, it goes to Step 25, wherein the appropriate viewer's favorite program is stored as favorite broadcast program data in the memory 25, and it goes to Step 26. In Step 26, a program list wherein the viewer's favorite program portion of the program list to be displayed is marked is prepared, and it goes to Step 27. In Step 27, the program list wherein the viewer's favorite program portion is marked is output to the display monitor 22 and the program list as shown in FIG. 5 is shown on the display panel 22a, leading to the end of the processing.

On the other hand, when it is judged that there is not a viewer's favorite program listed in the viewer's favorite program list among the read program list in Step 24, it goes to Step 28. In Step 28, a normal program list without marking is prepared, and it goes to Step 29, wherein the normal program list is output to the display monitor 22, leading to the end of the processing.

Here, in the above program list display processing, a case where the viewer's favorite program and other programs are listed in the form as shown in FIG. 5 is described, but in the broadcast terminal equipment according to another embodiment, a favorite program display switch may be arranged on the remote control 24, and in cases where the favorite program display switch is turned on, a program list of only programs listed in the favorite broadcast program data may be prepared and displayed as a viewer's original favorite program list.

In addition, in the above program list display processing, a program list with marking is prepared and displayed when the program list switch is turned on, but using the broadcast terminal equipment according to another embodiment, a program list wherein the favorite broadcast program portion is marked may be prepared and stored in the memory 25 when new program information data is acquired, and the program list with marking may be read out and shown in response to the input of the program list switch.

And in the above Step 22, the program list of the program information data stored in the memory 25 is read out and used. The program information data stored in the memory 25 is acquired through the digital broadcasting receiver 11, but the program list can be also captured by making an access to a program list providing site on the Internet.

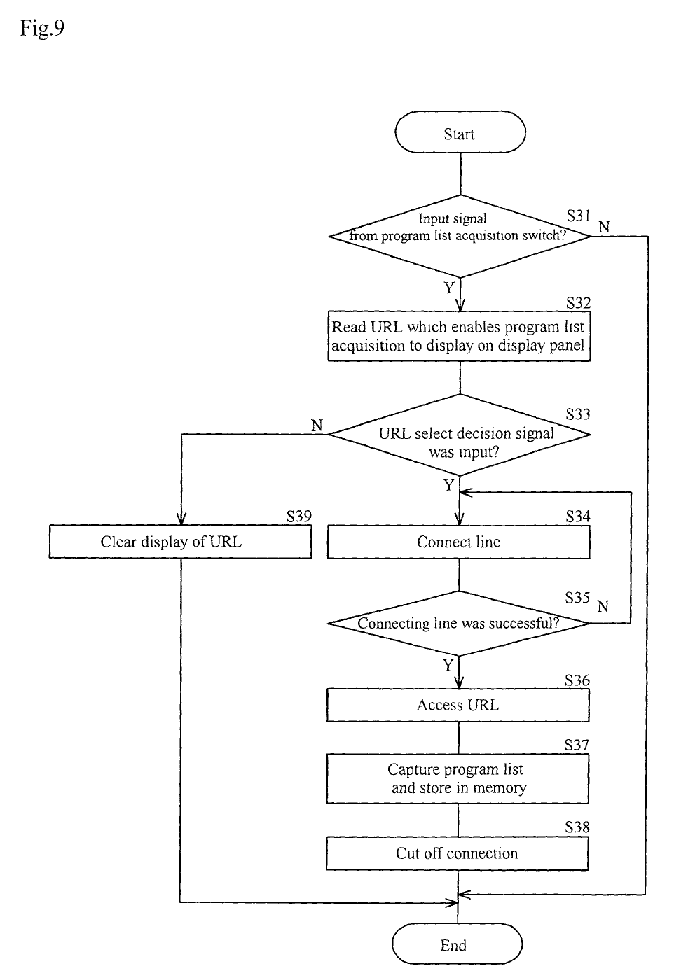

The program list acquiring operation via the Internet performed by the microcomputer 10 of the broadcast terminal equipment according to the embodiment (1) is described below by reference to a flow chart shown in FIG. 9.

In Step 31, whether there is an input signal from a program list acquisition switch arranged on the remote control 24 or not is judged. When it is judged that there was an input signal from the program list acquisition switch in Step 31, the operation goes to Step 32. In Step 32, a URL (Uniform Resource Locator) of a home page previously entered from which a program list can be acquired is read from the memory 25, the URL is displayed on the display panel 22a, and it goes to Step 33. The URL shown on the display panel 22a can be selected and decided by operating a prescribed key arranged on the remote control 24. In Step 33, whether the select decision signal of the URL is input or not is judged. When the select decision signal of the URL is judged to have been input in Step 33, it goes to Step 34, wherein the communication controller 28 is controlled so as to make a line connection, and it goes to Step 35. On the other hand, when the select decision signal of the URL is judged not to have been input in Step 33, it goes to Step 39, wherein the display of the URL is cleared, leading to the end of the processing.

In Step 35, whether the line connecting succeeds or not is judged. When the line connecting is judged to have succeeded, it goes to Step 36, wherein an access is made to the URL which provides a program list, and it goes to Step 37. On the other hand, when the line connecting is judged not to have succeeded in Step 35, it returns to Step 34 and the line connecting is conducted again.

In Step 37, a program list is captured from the URL to which an access was made, the program list is stored in the memory 25, and it goes to Step 38, wherein the cut-off of the line connection is conducted, leading to the end of the processing.

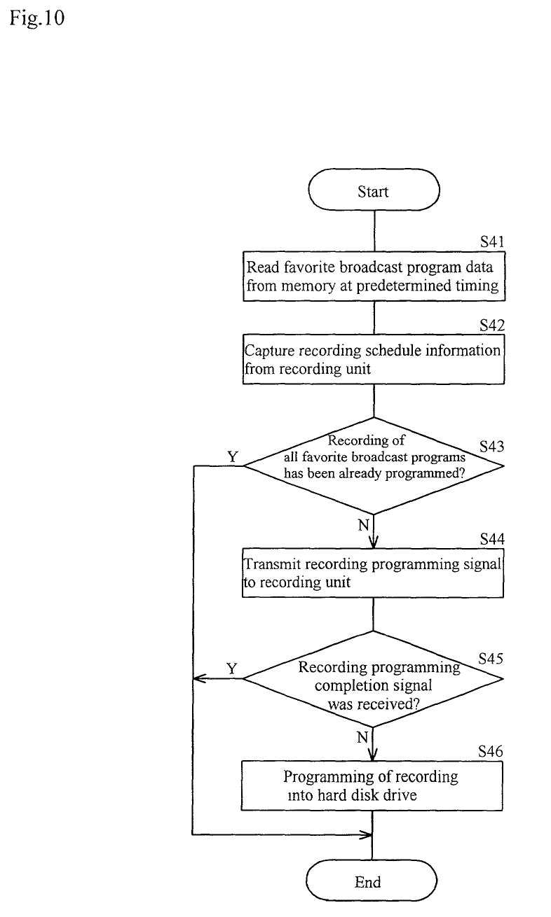

The automatic recording operation of favorite programs performed by the microcomputer 10 of the broadcast terminal equipment according to the embodiment (1) is described below by reference to a flow chart shown in FIG. 10.

In Step 41, the favorite broadcast program data stored in the memory 25 is read out at a predetermined timing, and the operation goes to Step 42. Here, the reading at the predetermined timing in Step 41 can be set according to the viewer's request so that, for example, it is conducted several minutes before the starting time of every favorite broadcast program stored in the favorite broadcast program data, or it is conducted at a given time once a day.

In Step 42, recording schedule information is captured from the outside recording unit 29 connected to the I/F 30, and it goes to Step 43. In Step 43, the favorite broadcast program data and the recording schedule information of the outside recording unit 29 are checked with each other and whether the recording of all of the favorite broadcast programs has been programmed or not is judged.

When the recording of all of the favorite broadcast programs is judged to have been programmed in Step 43, the processing is ended. On the other hand, when the recording of all of the favorite broadcast programs is not judged to have been programmed in Step 43, it goes to Step 44, wherein a recording programming signal for allowing the favorite broadcast program the recording of which has not been programmed yet to be recorded is transmitted to the outside recording unit 29, and it goes to Step 45. Here, the recording programming signal includes information such as the broadcast date, broadcast period of time and channel of the program, which are required for programming the recording of the favorite broadcast program, and the ID code for identifying the program, and based on the recording programming signal, the change of the recording programming is carried out in the outside recording unit 29.

In Step 45, whether or not a recording programming completion signal which shows that the recording programming was properly carried out is received from the outside recording unit 29 or not is judged. When the recording programming completion signal is judged to have been received from the outside recording unit 29 in Step 45, the processing is ended. On the other hand, when it is judged that the recording programming completion signal has not been received, or that the recording programming has not been finished because the amount of storage available of the storage medium which is set in the outside recording unit 29 is short, or the storage medium is not set therein, it goes to Step 46, wherein the programming for recording in the HDD 26 is conducted, leading to the end of the processing.

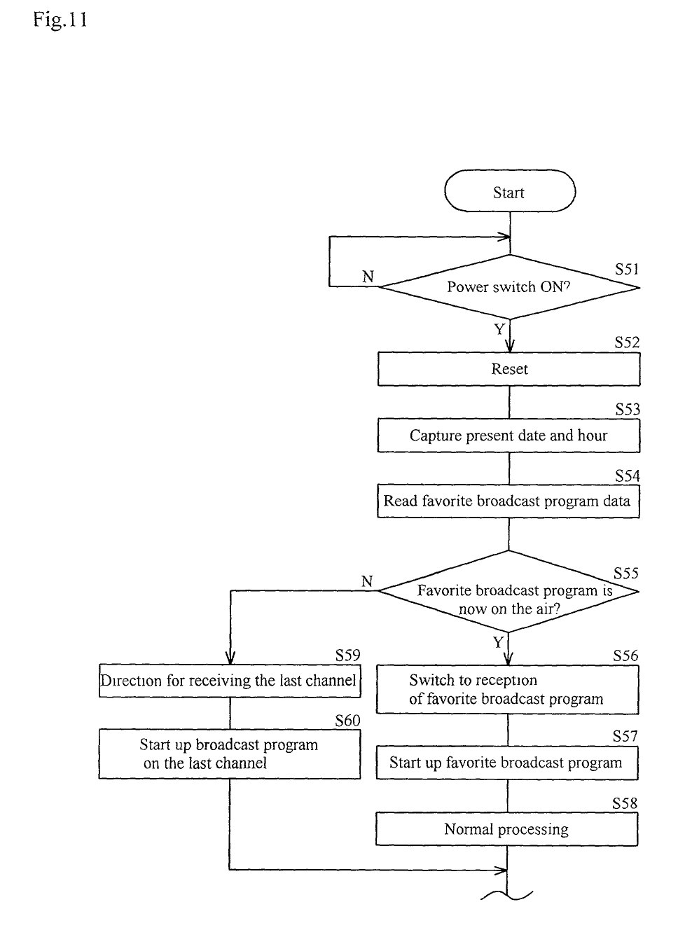

The first favorite program starting-up operation performed by the microcomputer 10 of the broadcast terminal equipment according to the embodiment (1) is described below by reference to a flow chart shown in FIG. 11. Here, this processing is conducted when the power switch arranged on the remote control 24 or the display monitor 22 is turned on.

In Step 51, whether the power switch is turned on or not is judged. When the power switch is judged to have been turned on in Step 51, the operation goes to Step 52, wherein resetting is conducted, and it goes to Step 53. On the other hand, when the power switch is judged not to have been turned on in Step 51, it returns to Step 51. In Step 53, the present date and hour is captured from the calendar timekeeping circuit 31, and in the following Step 54, the favorite broadcast program data is read from the memory 25, and it goes to Step 55. In Step 55, whether a favorite broadcast program is now on the air or not is judged.

When a favorite broadcast program is judged to be now on the air in Step 55, it goes to Step 56, wherein the reception switching to the channel of the favorite broadcast program is conducted. And the operation goes to Step 57, wherein the favorite broadcast program is started up. Then, it goes to Step 58, wherein the processing shifts to the normal processing.

On the other hand, when a favorite broadcast program is judged not to be now on the air in Step 55, it goes to Step 59, wherein a direction for receiving the last channel is given. Then, the operation goes to Step 60, wherein the broadcast program on the last channel is started up, and then it goes to Step 58, wherein the processing shifts to the normal processing. Here, the last channel in this case represents a channel which had been set to receive when the power switch was turned off the last time.

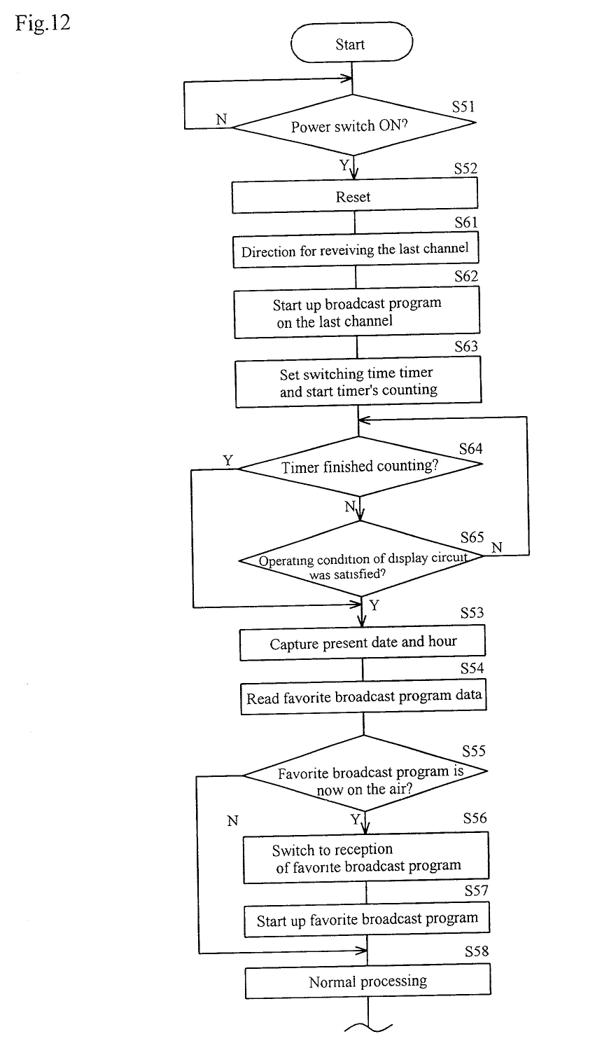

The second favorite program starting-up operation performed by the microcomputer 10 of the broadcast terminal equipment according to the embodiment (1) is described below by reference to a flow chart shown in FIG. 12.

The difference of the second favorite program starting-up operation from the first favorite program starting-up operation is that a program on the last channel is started up at first and it is switched to the viewer's favorite program to be started up after a prescribed period of time elapses or the operating condition of the display circuit for displaying the video on the display panel 22a is satisfied.

Here, the processing operations which are the same as the first favorite program starting-up operations shown in FIG. 11 are similarly marked, which are not described below.

In Step 51, whether the power switch is turned on or not is judged. When the power switch is judged to have been turned on in Step 51, the operation goes to Step 52, wherein resetting is conducted, and it goes to Step 61.

In Step 61, a direction for receiving the last channel is given. Then, it goes to Step 62, wherein the broadcast program on the last channel is started up, and then, it goes to Step 63. In Step 63, the switching time timer is set and the counting of the timer is started, and it goes to Step 64. Here, the setting time of the timer in Step 63 can be set to be a fixed time (e.g. a given time within 1-5 seconds), or set to be a random time (e.g. 0.5-3 seconds) of the free running counter within the microcomputer 10 or the like, or set to be about 4-5 seconds when the program on the last channel which had been watched at last is a favorite program.

In Step 64, whether the timer finished counting or not is judged. When the timer is judged to have finished counting in Step 64, it goes to Step 53, and in the following steps to Step 58, the starting-up of the favorite broadcast program is conducted similarly to the processing shown in FIG. 11 and the processing shifts to the normal processing.

On the other hand, when the timer is judged not to have finished counting in Step 64, it goes to Step 65, wherein whether the operating condition of the display circuit is satisfied or not is judged. Here, the judgment of the satisfied operating condition of the display circuit in Step 65 is conducted as follows. For example, when the display monitor 22 is a CRT display, the temperature of the heater portion is taken by a thermistor or the like, and the output voltage and the reference voltage are compared using a comparator or the like. If the output voltage is equal or more than the reference voltage, the operating condition of the display circuit for displaying the video on the CRT display is judged to have been satisfied, and a satisfied operating condition signal is output to the microcomputer 10. And when the display monitor 22 is an LCD display, whether the operating condition of the display circuit is satisfied or not may be judged by detecting the backlight luminance so as to output a satisfied operating condition signal to the microcomputer 10.

When the operating condition of the display circuit is judged to have been satisfied in Step 65, it goes to Step 53, and in Step 53 and the following steps, the same processing as that shown in FIG. 11 is conducted and the processing shifts to the normal processing.

On the other hand, when the operating condition of the display circuit is judged not to have been satisfied in Step 65, it returns to Step 64, and the processing of judging whether the timer finished counting or not is repeated again.

Using the broadcast terminal equipment according to the embodiment (1), a program list in which the viewer's favorite programs can be easily found out can be prepared on the basis of the viewer's program data, and the viewer can easily find out his/her favorite programs. Therefore, even if the number of programs increases with multiplied channels, it is possible to prevent the viewer from overlooking his/her favorite programs.

And since a program list can be automatically downloaded via the Internet, the viewer can see the program list without subscribing a newspaper, a magazine and the like. By making scattered program lists into one, the viewer can be provided with a program list which is easy for the viewer to see.

And even if the recording of the viewer's favorite program is not programmed, the viewer's favorite program can be automatically recorded in the HDD 26. Therefore, since the viewer's favorite program can be automatically recorded even if the viewer has forgotten programming the recording thereof, it is possible to avoid a failure to record the viewer's favorite program.

And even if the recording of the viewer's favorite program is not programmed, it is possible to transmit a recording direction signal to the outside recording unit 29 so as to record the viewer's favorite program. Therefore, the viewer's favorite program can be allowed to be recorded in the outside recording unit 29, leading to no failure to record the viewer's favorite program.

And when a viewer's favorite program is on the air on switch-on of power, the viewer's favorite program is first started up, so that the viewer can save the trouble of selecting his/her favorite program and watch the viewer's favorite program promptly.

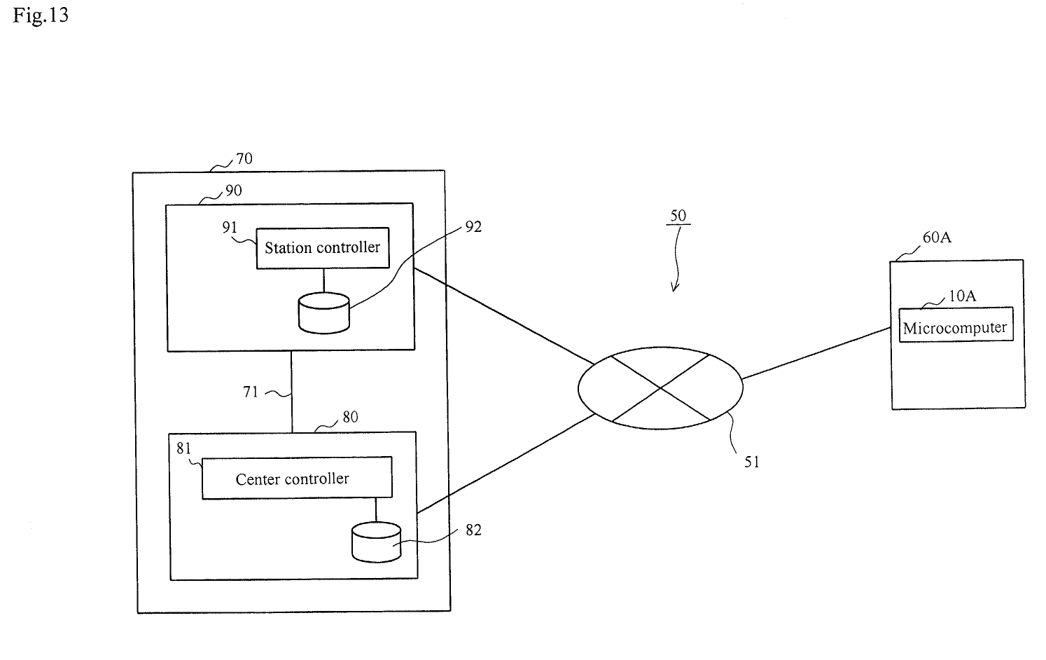

An information supply system (1) according to an embodiment is described below. FIG. 13 is a block diagram schematically showing the principal part of a digital broadcasting system in which the information supply system (1) according to the embodiment is adopted.

A digital broadcasting system 50 comprises broadcast terminal equipment 60A having a function of receiving digital broadcasting, and a broadcasting business company 70 which produces digital broadcast programs and broadcasts the programs. The broadcasting business company 70 comprises an information center 80 and a broadcast station 90. The broadcast terminal equipment 60A, the information center 80 and the broadcast station 90 are connected through pay station lines 51, and the information center 80 and the broadcast station 90 are connected through a dedicated line 71.

Since the construction of the broadcast terminal equipment 60A is almost the same as that of the broadcast terminal equipment according to the embodiment (1) shown in FIG. 1, only a microcomputer 10A having different functions is shown with a different mark and other components are not described here.

The information center 80 comprises a center controller 81 and a watching program database 82. The center controller 81 stores viewer's program data transmitted from the broadcast terminal equipment 60A in the watching program database 82, and conducts the control of analyzing the viewer's program data stored in the watching program database 82 and transmitting the analyzed data regarding the watching programs to the broadcast station 90. In the watching program database 82, the viewer's program data over about one to three months transmitted from the broadcast terminal equipment 60A is stored in the almost similar form of the storage format shown in FIG. 2.

The broadcast station 90 comprises a station controller 91 and a program specific information database 92. The station controller 91 conducts the control for searching and reading program specific information related to the analyzed data from the program specific information database 92 on the basis of the analyzed data transmitted from the information center 80, and transmitting the read program specific information to the broadcast terminal equipment 60A.

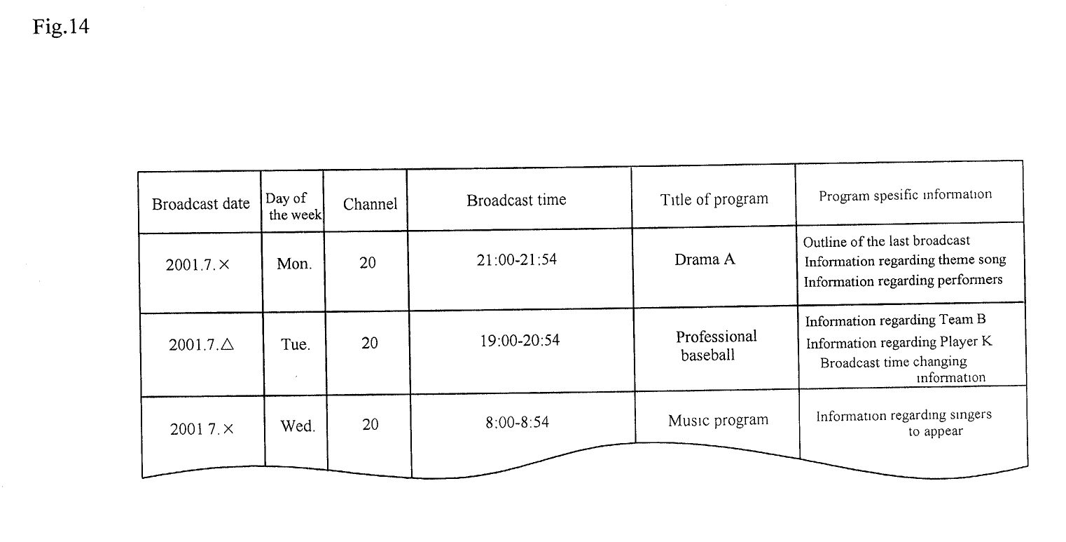

FIG. 14 is a diagram showing a storage format of the program specific information stored in the program specific information database 92, wherein information about the broadcast program (the broadcast date, day of the week, channel, broadcast time and program title) to which the program specific information is added and the program specific information for fans related to the broadcast program are stored. For example, in the case where the broadcast program is a drama, information about the outline and theme song of the drama, information about the performers and the like are stored as the information related to the drama.

In the case of a sportscast, information regarding the opposite team or players, information about a channel of the TV station or information about a channel of the radio station, which is continuously broadcasting the game when the relay broadcasting is finished in the middle of the game, and information regarding the longest extended time, changes in the timetable of the broadcast programs after the extension when the relay broadcasting of the game is extended, are stored. In the case of a music program, information about release of new songs or albums of singers to appear, concert tour information and the like are stored as information regarding the singers who appear.

In the microcomputer 10A of the broadcast terminal equipment 60A, the program specific information transmitted from the broadcast station 90 is received and the control for combining the information with the current watching program video for display is conducted. The viewer can obtain a variety of information suiting the viewer's taste by seeing the program specific information shown while watching the program.

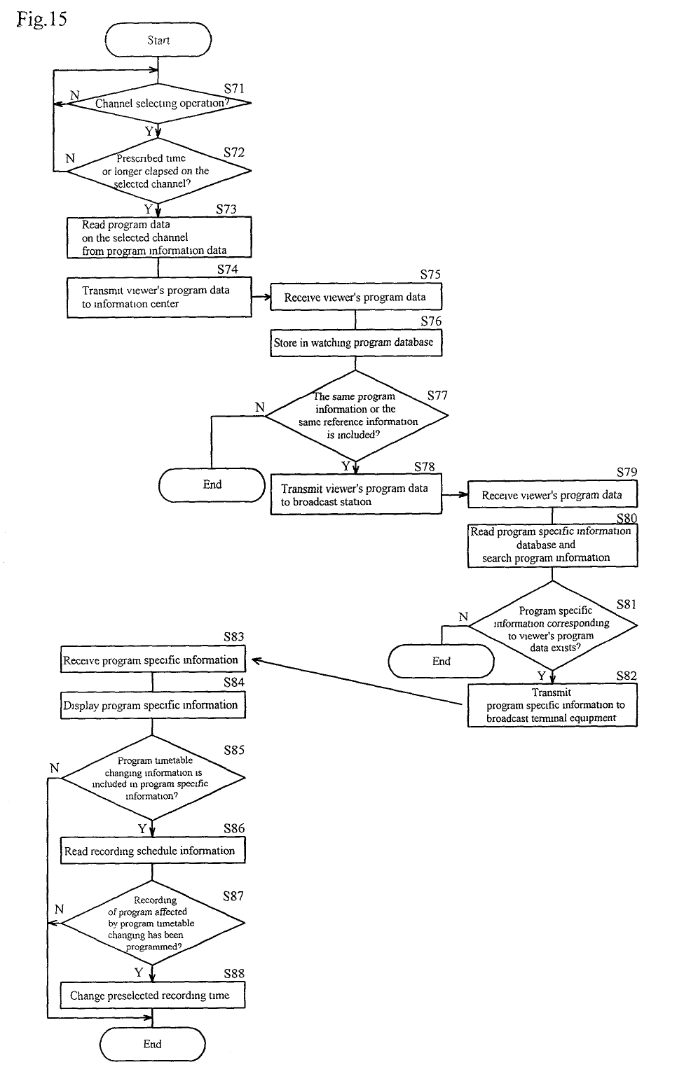

The information supplying operation conducted among the microcomputer 10A of the broadcast terminal equipment 60A, the center controller 81 of the information center 80 and the station controller 91 of the broadcast station 90 in the digital broadcasting system 50 in which the information supply system (1) according to the embodiment is adopted is described below by reference to a flow chart shown in FIG. 15.

At the broadcast terminal equipment 60A, in Step 71, whether a channel selecting operation is conducted or not is judged. When the channel selecting operation is judged to have been conducted in Step 71, the operation goes to Step 72, wherein a prescribed time or longer elapsed on the selected channel or not is judged. This step is conducted for judging whether the program on the selected channel is a program a viewer tries to watch or not, and the prescribed time may be set to be about 5 minutes.

When watching on the selected channel is judged to have continued for the prescribed time or longer in Step 72, it goes to Step 73, wherein program data on the selected channel is read as the viewer's program data from the program information data stored in the memory 25. Then it goes to Step 74, wherein the read viewer's program data is transmitted to the information center 80. On the other hand, when the channel selecting operation is judged not to have been conducted in Step 71, it returns to Step 71. And when it is judged that the prescribed time or longer did not elapse on the selected channel in Step 72, it returns to Step 71.

At the information center 80, in Step 75, the viewer's program data transmitted from the broadcast terminal equipment 60A is received, and the operation goes to Step 76, wherein the received viewer's program data is stored in the watching program database 82, and it goes to Step 77.

In Step 77, whether or not the same program information or the same reference information as the viewer's program data stored in Step 76 is included in viewer's program data already stored in the watching program database 82 is judged. This step is conducted for judging whether the current watching program on the broadcast terminal equipment 60A side is the viewer's favorite program or not. When the same program information or the same reference information as the transmitted viewer's program data is judged to be included therein in Step 77, it goes to Step 78, wherein the viewer's program data is transmitted to the broadcast station 90. In the viewer's program data, user information such as a user ID or a telephone number for identifying the broadcast terminal equipment 60A is included, besides the program data. On the other hand, when the same program information or the same reference information is judged not to be included therein in Step 77, the processing is ended.

At the broadcast station 90, in Step 79, the viewer's program data transmitted from the information center 80 is received, and it goes to Step 80, wherein the program specific information database 92 for the program fans is read and program information corresponding to the viewer's program data is searched. Then it goes to Step 81, wherein whether or not program specific information corresponding to the viewer's program data exists in the program specific information database 92 is judged. When program specific information corresponding to the viewer's program data is judged to be therein in Step 81, it goes to Step 82, wherein the program specific information is transmitted to the broadcast terminal equipment 60A on the basis of the user information. On the other hand, when program specific information corresponding to the viewer's program data is judged not to be therein in Step 81, the processing is ended.

At the broadcast terminal equipment 60A, in Step 83, the program specific information for the fans transmitted from the broadcast station 90 is received, and the operation goes to Step 84, wherein picture superimposing is conducted for on-screen display of the program specific information as a telop or textual information on the current watching program video and it is output to the display monitor 22 for display on the display panel 22a, and it goes to Step 85.

In Step 85, whether or not program timetable changing information is included in the program specific information is judged. When program timetable changing information is judged to be included, it goes to Step 86, wherein recording schedule information is read, and it goes to Step 87. On the other hand, when program timetable changing information is judged not to be included, the processing is ended.

In Step 87, whether or not recording of a program affected by program timetable changing, or a program whose broadcast time was changed or a program after the program whose broadcast time was changed, has been programmed is judged. When the recording of a program affected by program timetable changing is judged to have been programmed, it goes to Step 88, wherein the preselected recording time is changed, leading to the end of the processing. Here, in order to change the preselected recording time, the programming of a changed recording time is carried out on the basis of a programming change code and the like included in the specific information transmitted from the broadcast station 90. On the other hand, when the recording of a program affected by program timetable changing is judged not to have been programmed, the processing is ended.

Using the above information supply system (1) according to the embodiment, the broadcast terminal equipment 60A can acquire the program specific information transmitted from the broadcast station 90 and provide the viewer with the program specific information. As a result, the viewer can obtain useful information suiting the viewer's taste such as detailed information of the program, information about performers and changed program timetable information by seeing the program specific information related to the watching program, leading to an improvement in convenience of the viewer.

When the program specific information includes information about changing of the broadcast time of a scheduled recording program, it is possible to change the recording time of the scheduled recording program and record it, so that a failure to record the scheduled recording program due to the change of the broadcast time can be prevented.

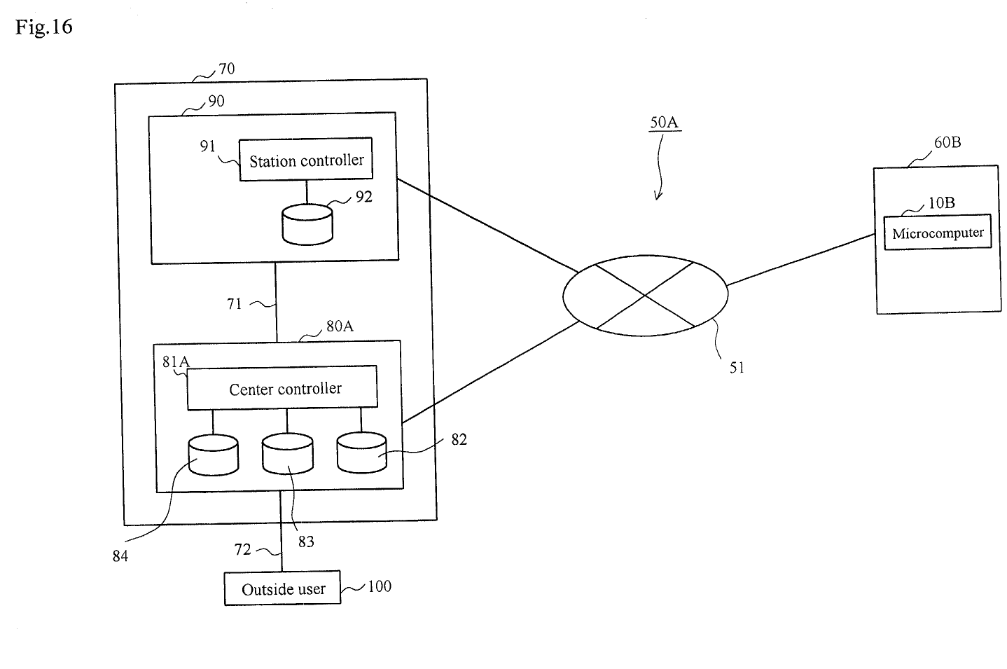

An information supply system (2) according to an embodiment is described below. FIG. 16 is a block diagram schematically showing the principal part of a digital broadcasting system 50A in which the information supply system (2) according to the embodiment is adopted. Here, the same components as those in the information supply system (1) shown in FIG. 13 are similarly marked, which are not described below.

The difference of the digital broadcasting system 50A from the digital broadcasting system 50 shown in FIG. 13 is that an information center 80A, having a receiving operation information database 83 and a viewer's information database 84, and an outside user 100 are connected using a dedicated line 72. The outside user 100 can use viewer's information in the viewer's information database 84.

Since the construction of broadcast terminal equipment 60B is almost the same as that of the broadcast terminal equipment according to the embodiment (1) shown in FIG. 1, only a microcomputer 10B having different functions is marked differently and other components are neither mentioned nor described here.

As the outside user 100, a package delivery company, a bill collector of the charge for the newspaper, reception fee and the like are included. The outside user 100 and the information center 80A may be connected using a pay station line.

As a center controller 81A of the information center 80A stores receiving operation information transmitted from the broadcast terminal equipment 60B in the receiving operation information database 83, it conducts the control of analyzing the receiving operation information stored in the receiving operation information database 83, preparing viewer's information for presuming the at-home state of the viewer, storing the prepared viewer's information in the viewer's information database 84, and transmitting the viewer's information to the outside user 100 when the use of the viewer's information is requested by the outside user 100 previously registered as a user.

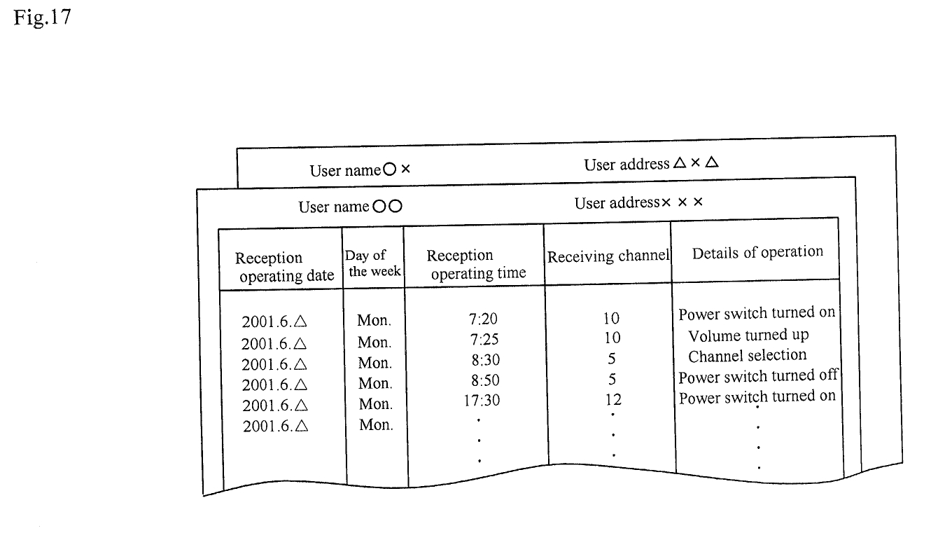

FIG. 17 is a diagram showing a storage format of the receiving operation information stored in the receiving operation information database 83. In the receiving operation information database 83, the receiving operation information of every user of the broadcast terminal equipment 60B transmitted from the broadcast terminal equipment 60B to the information center 80A is stored. The receiving operation information includes the reception operating date, day of the week, reception operating time, receiving channel, details of operation, and registered user name, address in record and the like as user information, and the receiving operation information is stored for a predetermined period.

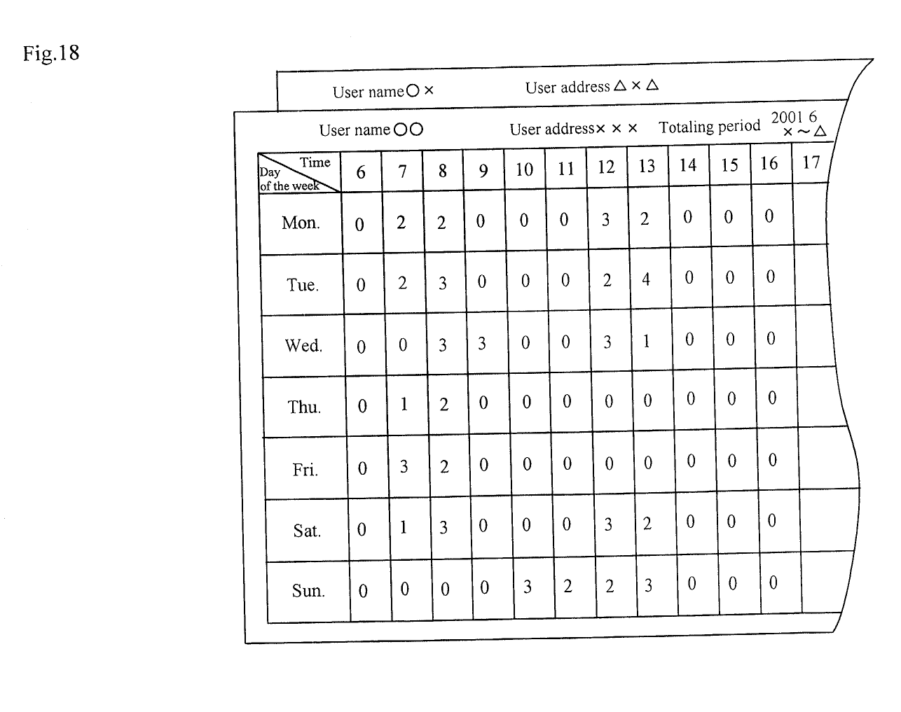

FIG. 18 is a diagram showing a storage format of the viewer's information stored in the viewer's information database 84. In the viewer's information database 84, receiving operation total information obtained by a statistical research of the receiving operation information of every registered user is stored. In the receiving operation total information, a table wherein the number of receiving operations every day of the week is totaled by time period in weeks, and a table showing by time period the number of receiving operations every day of the week in months wherein the data of the past 4 weeks are totaled are stored. By preparing such tables wherein distribution in time period of the number of the receiving operations is worked out, the day of the week and the time period when the number of the receiving operations is large can be grasped in weeks or in months through the tables, and it can be presumed that there is a high probability of the viewer's at-home in the time period.

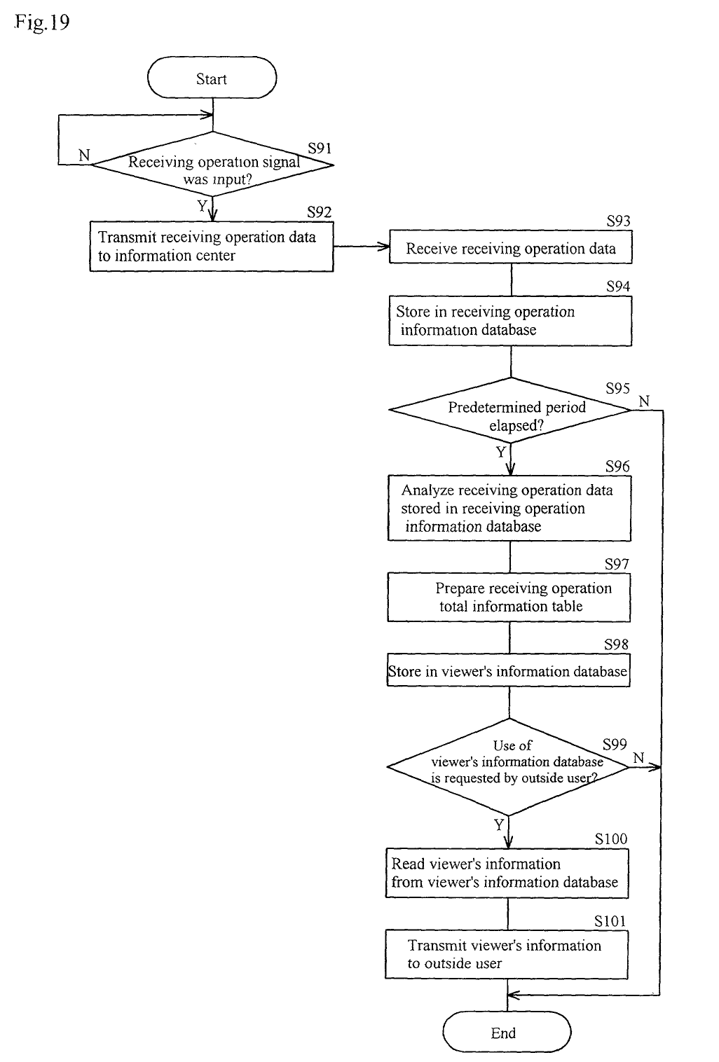

The information supplying operation performed by the microcomputer 10B of the broadcast terminal equipment 60B and the center controller 81A of the information center 80A in the digital broadcasting system 50A in which the information supply system (2) according to the embodiment is adopted is described below by reference to a flow chart shown in FIG. 19.

At the broadcast terminal equipment 60B, in Step 91, whether a receiving operation signal is input from a remote control 24 or not is judged. When a receiving operation signal is judged to have been input, the operation goes to Step 92, wherein the receiving operation data is transmitted to the information center 80A. When a receiving operation signal is judged not to have been input in Step 91, the operation returns to Step 91. Here, the receiving operation signals input from the remote control 24 include signals of operating a channel selection key, a volume control key, other input changing keys, a setting input key and the like arranged in button switches 24a on the remote control 24 or button switches 22b on a display monitor 22.

At the information center 80A, in Step 93, the receiving operation data transmitted from the broadcast terminal equipment 60B is received, and it goes to Step 94. In Step 94, the received receiving operation data is stored in the receiving operation information database 83, and it goes to Step 95.

In Step 95, whether a predetermined period, for example, one week elapsed or not is judged. As the predetermined period in this case, it may be a period suitable for grasping the at-home state from the receiving operation data. When the predetermined period is judged not to have elapsed in Step 95, the processing is ended. On the other hand, when the predetermined period is judged to have elapsed, it goes to Step 96, wherein the receiving operation data stored in the receiving operation information database 83 is analyzed, and it goes to Step 97. In the analysis of the receiving operation data, the number of receiving operations of every day of the week is totaled by time periods in weeks, or the number of receiving operations of every day of the week in months is totaled by time periods based on the data of the past 4 weeks.

In Step 97, a table showing receiving operation total information as shown in FIG. 18 is prepared on the basis of the analyzed receiving operation information, and it goes to Step 98, wherein the table is stored in the viewer's information database 84, and then it goes to Step 99.

In Step 99, whether use of the viewer's information database 84 is requested by the outside user 100 or not is judged. When the use of the viewer's information database 84 is judged to be requested by the outside user 100 in Step 99, it goes to Step 100, wherein viewer's information requested is read from the viewer's information database 84. Then, it goes to Step 101, wherein the read viewer's information is transmitted to the outside user 100, leading to the end of the processing. On the other hand, when the use thereof is judged not to be requested by the outside user 100 in Step 99, the processing is ended.

Using the information supply system (2) according to the embodiment, the information center 80A collects receiving operation data transmitted from the broadcast terminal equipment 60B, and viewer's information such as the at-home state of the viewer can be presumed from the collected receiving operation data. And the presumed viewer's information can be transmitted to the outside user 100 who utilizes the viewer's information. As a result, the outside user 100 who received the viewer's information can provide the viewer with efficient services by making use of the viewer's information. For example, if the outside user 100 is a package delivery company or a bill collector, the second trouble such as redelivery in the case of the viewer's absence can be reduced by delivering or collecting money in the time period when it is presumed from the viewer's information that the probability of the viewer's at-home is high, leading to high efficiency of delivery or money collecting.

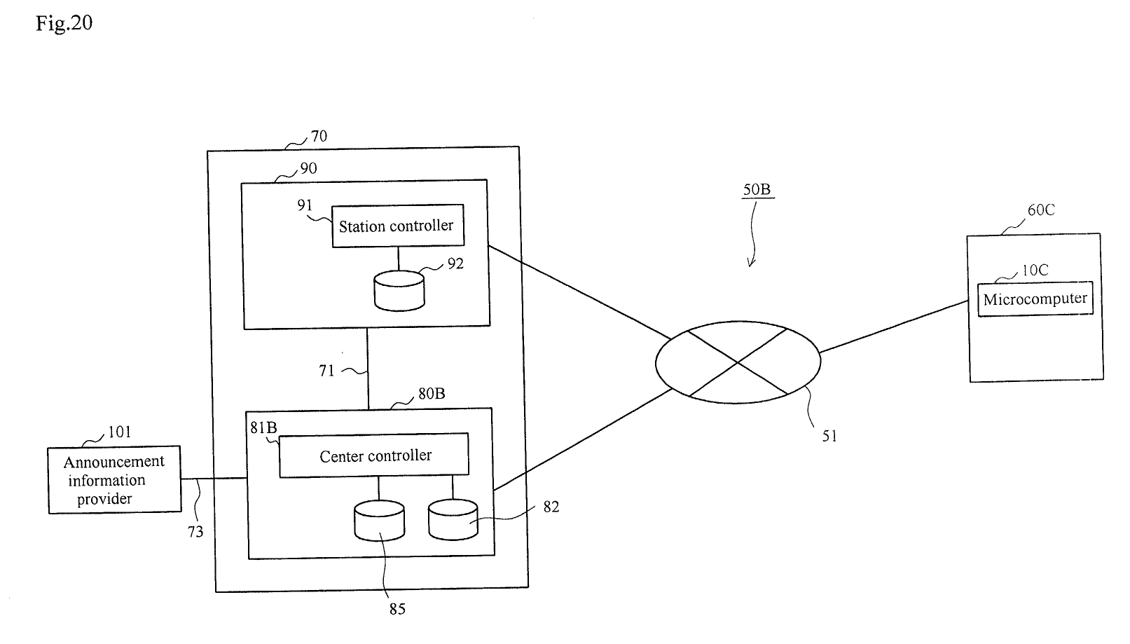

An information supply system (3) according to an embodiment is described below. FIG. 20 is a block diagram schematically showing the principal part of a digital broadcasting system 50B in which the information supply system (3) according to the embodiment is adopted. Here, the same components as those in the information supply system (1) shown in FIG. 13 are similarly marked, which are not described below.

The difference of the digital broadcasting system SOB from the digital broadcasting system 50 shown in FIG. 13 is that an announcement information database 85 is connected to a center controller 81B of an information center 80B, which is connected with an announcement information provider 101 using a dedicated line 73. The announcement information provider 101 can enter announcement information into the announcement information database 85.

Since the construction of broadcast terminal equipment 60C is almost the same as that of the broadcast terminal equipment according to the embodiment (1) shown in FIG. 1, only a microcomputer 10C having different functions is differently marked and other components are not described below.

As the announcement information provider 101, companies which sell articles related to broadcast programs or provide information such as distributors of various kinds of tickets of singers, sports, movies and the like are included. The announcement information provider 101 and the information center 80B may be connected using a pay station line.

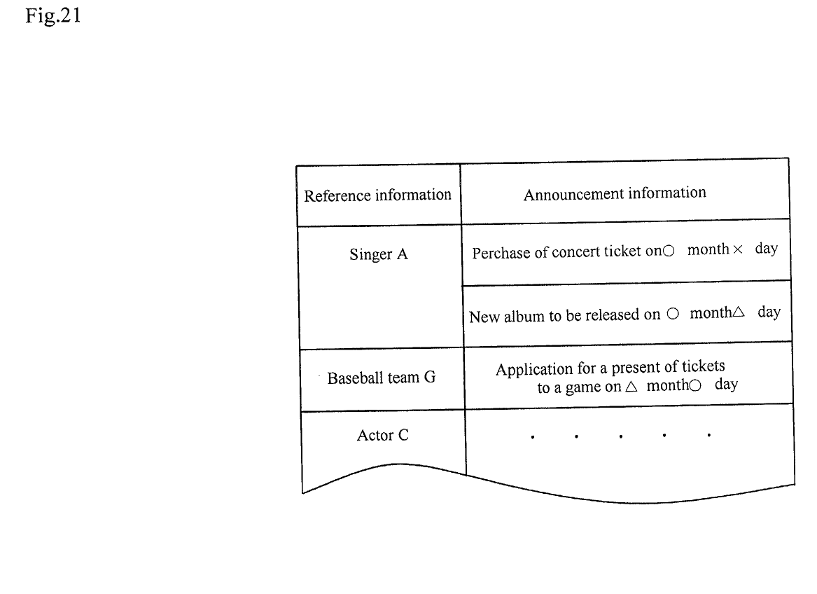

FIG. 21 is a diagram showing a storage format of the announcement information stored in the announcement information database 85, in which reference information and announcement information corresponding to every reference information are stored. These items of announcement information are transmitted from the outside announcement information provider 101, and after being associated with reference information, they are stored in the announcement information database 85. If the reference information is a singer, for example, information regarding a reservation or purchase of concert tickets, or release of a new album is included in the announcement information, and if the reference information is a professional baseball team, information regarding an application for a present of tickets to games or purchase of tickets to games is included therein.

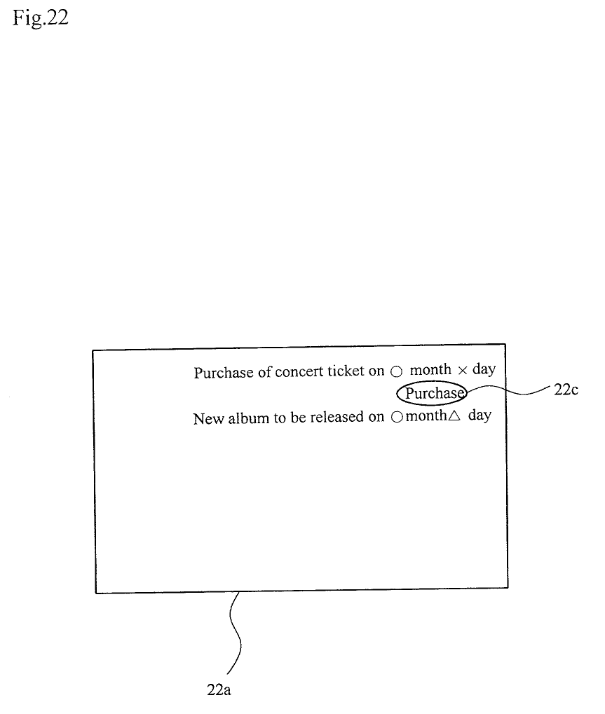

FIG. 22 shows an example of display of announcement information on a display panel 22a of the broadcast terminal equipment 60C. The announcement information is superimposed with the picture of the current watching program for on-screen display on the program picture. By operating a remote control 24 to an icon 22c of ticket purchase displayed on the screen and carrying out an input operation of a prescribed select decision switch, the viewer can purchase the ticket. Here, prescribed settings for electronic shopping are previously registered.

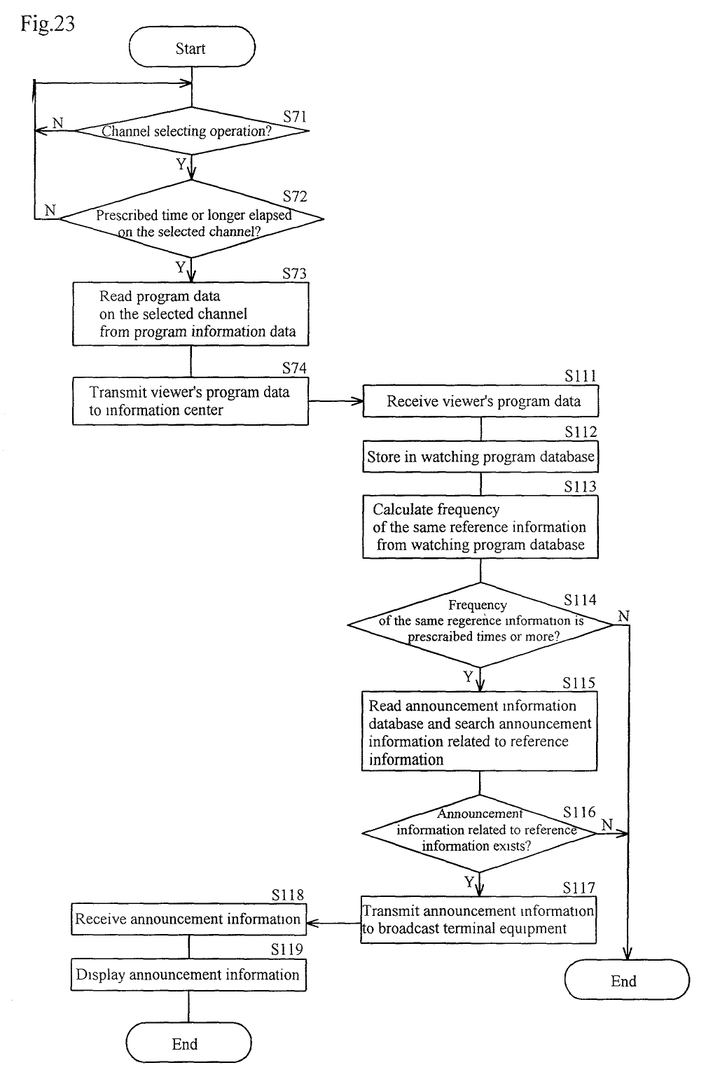

The information supplying operation performed by the microcomputer 10C of the broadcast terminal equipment 60C and the center controller 81B of the information center 80B in the information supply system (3) according to the embodiment is described below by reference to a flow chart shown in FIG. 23. Here, the same operations as those shown in FIG. 15 are similarly marked, which are not described below.

At the broadcast terminal equipment 60C, in Step 74, viewer's program data read from a memory 25 is transmitted to the information center 80B.

At the information center 80B, in Step 111, the viewer's program data transmitted from the broadcast terminal equipment 60C is received, and the operation goes to Step 112, wherein the received viewer's program data is stored in a watching program database 82, and it goes to Step 113.

In Step 113, the frequency of viewer's program data including the same reference information as that of the viewer's program data stored in Step 112 is calculated from the viewer's program data stored in the watching program database 82. In the next Step 114, whether or not the frequency of the same reference information is a prescribed times or more is judged. When the frequency of the same reference information is judged to be the prescribed times or more in Step 114, it goes to Step 115. In Step 115, the announcement information database 85 is read and searching for finding announcement information related to the reference information from the announcement information database 85 is conducted, and it goes to Step 116.

In Step 116, whether announcement information related to the reference information exists or not is judged. When announcement information related to the reference information is judged to exist, it goes to Step 117, wherein the announcement information is transmitted to the broadcast terminal equipment 60C, and it goes to Step 118.

On the other hand, when the frequency of the same reference information is judged not to be the prescribed times or more in Step 114, the processing is ended. And when announcement information related to the reference information is judged not to exist in Step 116, the processing is ended.

At the broadcast terminal equipment 60C, in Step 118, the announcement information transmitted from the information center 80B is received. Then, it goes to Step 119, wherein the announcement information is superimposed with the picture of the current watching program and displayed on a display panel 22a, leading to the end of the processing.

Using the information supply system (3) according to the embodiment, the broadcast terminal equipment 60C can receive the announcement information transmitted from the information center 80B and provide the viewer with the announcement information related to the reference information such as tickets of concerts, sports and the like. As a result, the viewer can obtain attractive announcement information suiting his/her taste while watching a program, and can make a reservation or a purchase of a ticket, or an application for a present according to the announcement information, leading to a higher convenience of the viewer. In addition, the announcement information provider 101 can effectively promote sales of goods such as tickets, thanks to the supply of the announcement information to fans.

What is claimed is:

1. Broadcast terminal equipment, comprising:
a viewer's program data storage device to store program data related to programs a viewer watched;
an each viewer's program list preparing device to prepare a favorite program list of the viewer, based on the program data stored in the viewer's program data storage device;
a favorite program detecting device to detect a program which fits into the favorite program list of the viewer prepared by the each viewer's program list preparing device in a program list received from a broadcasting business company side; and
a differentiated display device to differentiate the program portion which fits into the favorite program list of the viewer detected in the program list by the favorite program detecting device from other program portions for display when the program list is displayed.

2. Broadcast terminal equipment, comprising:
a viewer's program data storage device to store program data related to programs a viewer watched;
an each viewer's program list preparing device to prepare a favorite program list of the viewer, based on the program data stored in the viewer's program data storage device;
a favorite program detecting device to detect a program which fits into the favorite program list of the viewer prepared by the each viewer's program list preparing device in a program list received from a broadcasting business company side;
a programmed recording schedule check device to make sure of the programmed recording schedule of the favorite program of the viewer detected by the favorite program detecting device; and
a recording control device to allow the favorite program of the viewer to be automatically recorded in a storage device when it is made sure by the programmed recording schedule check device that the programming of recording of the viewer's favorite program detected by the favorite program detecting device has not been conducted.

3. Broadcast terminal equipment, comprising:
a viewer's program data storage device to store program data related to programs a viewer watched;
an each viewer's program list preparing device to prepare a favorite program list of the viewer, based on the program data stored in the viewer's program data storage device;
a favorite program detecting device to detect a program which fits into the favorite program list of the viewer prepared by the each viewer's program list preparing device in a program list received from a broadcasting business company side;
a programmed recording schedule check device to make sure of the programmed recording schedule of the favorite program of the viewer detected by the favorite program detecting device; and
a recording direction device to transmit a recording direction signal to an outside recording unit so as to record the favorite program of the viewer when it is made sure by the programmed recording schedule check device that the programming of recording of the viewer's favorite program detected by the favorite program detecting device has not been conducted.

4. Broadcast terminal equipment according to claim 1, comprising:
a program on-air detecting device to detect whether a favorite program of the viewer detected by the favorite program detecting device is on the air at turn-on of power; and
a favorite program start-up device to start up the viewer's favorite program when the viewer's favorite program is detected being on the air by the program on-air detecting device.

5. Broadcast terminal equipment according to claim 4, wherein the favorite program start-up device starts up the viewer's favorite program a prescribed time after a start-up on the last channel or the like.

6. Broadcast terminal equipment according to claim 4, wherein the favorite program start-up device starts up the viewer's favorite program a prescribed random time after a start-up on the last channel or the like.

7. Broadcast terminal equipment according to claim 4, comprising:
a satisfied display condition judging device to judge the satisfaction of a display condition;
wherein the favorite program start-up device starts up the viewer's favorite program when the satisfied display condition judging device judges the display condition to have been satisfied after a start-up on the last channel or the like.

8. Broadcast terminal equipment according to claim 1, wherein the program data stored in the viewer's program data storage device includes reception information such as the watching date, day of the week, receiving channel and watching time, and reference information such as genre classification into movie, news, sports, drama and the like previously entered in the program data and personality information such as actors, singers and TV personalities to appear.

9. Broadcast terminal equipment, comprising:
a display control device to display a home page address to acquire a program list prepared by a broadcast station based on the input of an operating signal from an operating device whereby various types of setting operations can be conducted;
an access device to access the home page address based on the selection of the home page address displayed by the control of the display control device; and
a storage control device to download the program list through the home page accessed by the access device.

10. An information supply system, wherein:
broadcast terminal equipment comprises a viewer's program data storage device to store program data related to programs a viewer watched, and
a program data transmitting device to transmit the program data stored in the viewer's program data storage device to an information center; and
the information center comprises a first specific information transmitting device to analyze the program data transmitted by the program data transmitting device and add specific information suiting the viewer's program taste to the program data so as to transmit the same to the broadcast terminal equipment.

11. An information supply system, wherein:
broadcast terminal equipment comprises a viewer's program data storage device to store program data related to programs a viewer watched, and
a program data transmitting device to transmit the program data stored in the viewer's program data storage device to an information center;
the information center comprises an analyzed data transmitting device to analyze the program data transmitted by the program data transmitting device and transmit the analyzed data to a broadcast station; and
the broadcast station comprises a second specific information transmitting device to add specific information suiting the viewer's program taste based on the analyzed data transmitted by the analyzed data transmitting device so as to transmit the same to the broadcast terminal equipment.

12. An information supply system according to claim 10, wherein the broadcast terminal equipment comprises a recording time changing device to change the preselected recording time of a program to be recorded, when the specific information transmitted by the first specific information transmitting device or the second specific information transmitting device includes information about a changed broadcast time of the program to be recorded.

13. An information supply system according to claim 10, wherein the program data stored in the viewer's program data storage device includes reception information such as the watching date, day of the week, receiving channel and watching time, and reference information such as genre classification into movie, news, sports, drama and the like previously entered in the program data and personality information such as actors, singers and TV personalities to appear.

14. An information supply system, wherein communication is conducted between broadcast terminal equipment and an information center, in which information about receiving operation of the broadcast terminal equipment can be grasped:
the broadcast terminal equipment, comprising;
a receiving operation data transmitting device to transmit the receiving operation data of a viewer on the broadcast terminal equipment to the information center; and
the information center, comprising;
a receiving operation data collecting device to collect the receiving operation data transmitted from the broadcast terminal equipment,
a viewer's information presumption device to presume the viewer's at-home state, the viewer's age and the like based on the receiving operation data collected by the receiving operation data collecting device, and
a viewer's information transmitting device to transmit the viewer's information presumed by the viewer's information presumption device to a user of the viewer's information.

15. An information supply system, wherein communication is conducted between broadcast terminal equipment and an information center, in which receiving program data of the broadcast terminal equipment can be grasped:
the broadcast terminal equipment, comprising;
a viewer's program data storage device to store program data related to programs a viewer watched, and
a program data transmitting device to transmit the program data stored in the viewer's program data storage device to the information center; and
the information center, comprising;
a program data collecting device to collect the program data transmitted from the broadcast terminal equipment,
a reference information frequency totaling device to total the frequency of reference information included in the program data based on the program data collected by the program data collecting device,
an announcement information searching device to search an announcement information database in which announcement information for sales promotion related to the reference information is entered for the announcement information related to the reference information, when some information having a frequency of a prescribed times or more exists in the reference information based on the totaling results by the reference information frequency totaling device, and
an announcement information transmitting device to transmit announcement information to the broadcast terminal equipment when the announcement information related to the reference information is found by the announcement information searching device.
